(19) United States
(12) Patent Application Publication
(10) Pub. No.: US 2008/0110820 A1
(43) Pub. Date: May 15, 2008

(54) Gravity Flow Carbon Block Filter

(76) Inventors: Elizabeth Louise Knipmeyer, Dublin, CA (US); Toni L. Lynch, Antioch, CA (US); Bruce D. Saaski, Caldwell, ID (US)

Correspondence Address: THE CLOROX COMPANY, P.O. BOX 24305, OAKLAND, CA, 94623-1305, US

(21) Appl. No.: 11/927,372

(22) Filed: Oct. 29, 2007

Related U.S. Application Data
(63) Continuation-in-part of application No. 10/881,517, filed on Jun. 30, 2004.

(51) Int. Cl. B01D 24/00; B01D 35/00

(52) U.S. Cl. 210/474; 210/510.1; 210/501; 210/257.1; 210/282; 210/477

(57) ABSTRACT

A gravity fed carbon block water filter includes activated carbon particles; a binder material interspersed with the activated carbon particles; and a lead scavenger coupled to at least one of the activated carbon particles and binder material, the lead scavenger being for removing lead from water, where a lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter, and where the water has an average flow rate of at least 0.1 liter per minute through the filter with a head pressure of between approximately 0.1 and 1.0 psi.

### RELATED APPLICATIONS

This application is a continuation-in-part of U.S. patent application Ser. No. 10/881,517, filed Jun. 30, 2004.

### FIELD OF THE INVENTION

The present invention relates to gravity flow filtration systems, and more particularly, this invention relates to carbon block filters having rapid flow rates, excellent filtration performance and high contaminant reduction.

### BACKGROUND OF THE INVENTION

The use of home water treatment systems to treat tap water continues to grow dramatically in the U.S. and abroad, in part because of heightened public awareness of the health concerns associated with the consumption of untreated tap water.

Several different methods are known for filtration of water, and various devices and apparatus have been designed and are commercially available. These methods and devices vary depending on whether the application is for industrial use or for household use.

Water treatment for household use is typically directed to providing safer drinking water. The methods and devices typically used in households for water treatment can be classified into two basic types. One type is pressurized system, such as a faucet mount system, and typically uses a porous carbon block as part of the filtration system. The other type is a low pressure system, such as a pour-through pitcher system, and typically uses activated carbon granules as part of the filtration system.

Filtration of water in a pressurized system has the advantage of the pressure to drive the filtration through the carbon block and therefore does not usually face problems of achieving desired flow rate while maintaining effective filtration of contaminants. However, when carbon blocks designed for pressurized systems are applied to gravity fed systems, they fail to produce the desired flow rates consistently over time.

Filtration of water in a low pressure system faces the challenge of undesirable contaminants while maintaining a desired high flow rate. However, when carbon blocks designed for pressurized systems are applied to gravity flow systems, they fail to produce the desired flow rates consistently over time.

Gravity flow filtration systems are well known in the art. Such systems include pour-through carafes, water coolers and refrigerator water tanks, which have been developed by The Clorox Company (BRITA®), Culligan™, Rubbermaid™ and Glacier Pure™.

Typically, these systems are filled with tap water from municipal supplies or rural wells, as the user wishes to remove chlorine and/or lead or other contaminants, or to generally improve the taste and odor of the water. These devices continue to be very popular, especially in view of the emphasis on healthy drinking water and in view of the expense and inconvenience of purchasing bottled water.

Pour-through carafe systems typically include an upper reservoir for receiving unfiltered water, a lower reservoir for receiving and storing filtered water, and a filtration cartridge with an inlet at its top and outlet at its bottom, through which cartridge, water flows from the upper reservoir to the lower reservoir. The pour-through carafe is sized to be handheld, holds about two liters of water, and may be tipped for pouring filtered water, as in a conventional pitcher or carafe.

Refrigerator tank systems typically include a larger rectangular tank with a spigot for draining filtered water into a glass or pan. Both carafe and refrigerator tank systems use gravity to move the unfiltered water in the top reservoir down through a filtration cartridge and into the lower reservoir where the filtered water remains until it is used.

The filtration cartridge typically employed in pour-through (or gravity flow) systems holds blended media of approximately 20×50 mesh granular activated carbon and either an ion exchange resin, which most typically contains a weak acid cation exchange resin, or a natural or artificial zeolite that facilitates the removal of certain heavy metals, such as lead and copper. Weak acid cation exchange resins can reduce the hardness of the water slightly, and some disadvantages are also associated with their use: first, they require a long contact time to work properly, which limits the flow rate to about one-third liter per minute; second, they take up a large amount of space inside the filter (65% of the total volume) and thus limit the space available for activated carbon.

A further problem associated with blended media of granular carbon and ion exchange resin is that they have limited contaminant removal capability due to particle size and packing geometry of the granules. When large granules are packed together, large voids can form between the granules. As water passes through the packed filter bed, it flows through the voids. Much of the water in the voids does not come into direct contact with a granule surface where contaminants can be adsorbed. Contaminant molecules must diffuse through the water in the voids to granule surfaces in order to be removed from the water. Thus, the larger the voids, the larger the contaminant diffusion distances. In order to allow contaminants to diffuse over relatively long distances, long contact time is required for large granular media to remove a significant amount of contaminant molecules from the water.

Conversely, small granules (i.e., 100-150 μm) form small voids when packed together, and contaminants in water within the voids have small distances over which to diffuse in order to be adsorbed on a granule surface. As a result, shorter contact time between the water and the filter media is required to remove the same amount of contaminant molecules from the water for filter media with small granules than for filter media with large granules.

But there are some drawbacks to using filter media with small granules. Water flow can be slow because the packing of the granules can be very dense, resulting in long filtration times. Also, small granules can be more difficult to retain within the filter cartridge housing.

It would be useful to have a gravity flow filter that exhibits both good water flow rates and high containment reduction.

### SUMMARY OF THE INVENTION

A gravity fed carbon block water filter according to one embodiment of the present invention includes activated carbon particles; a binder material interspersed with the activated carbon particles; and a lead scavenger coupled to at least one of the activated carbon particles and binder material, the lead scavenger being for removing lead from water, where a lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter, and where the water has an average flow rate of at least 0.1 liter per minute through the filter with a head pressure of between approximately 0.1 and 1.0 psi.

The lead scavenger may be a zirconia hydroxide, or any other lead scavenging material.

The binder material is preferably hydrophobic, but need not be. In one approach, the binder material has a melt index that is less than 1.8 g/10 min as determined by ASTM D 1238 at 190° C. and 15 kg load. In another approach, the binder material has a melt index that is less than 1.0 g/10 min as determined by ASTM D 1238 at 190° C. and 15 kg load.

In one embodiment, the structure of the block is characterized by having been compressed no more than 10% by volume during fabrication of the filter.

A gravity-fed carbon block water filter according to another embodiment of the present invention includes activated carbon particles; and a binder material interspersed with the activated carbon particles. The binder material has a melt index that is less than 1.8 g/10 min as determined by ASTM D 1238 at 190° C. and 15 kg load. A structure of the block is characterized by having been compressed less than about 10% by volume during fabrication of the filter. A lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter. Water passing through the filter has an average flow rate of at least 0.1 liter per minute through the filter with a head pressure of between approximately 0.1 and 1.0 psi.

Additional active materials may be present. In one approach, about 5-40 wt % of additional active material including a lead scavenger such as zirconia hydroxide may be present.

The binder material is preferably hydrophobic, but need not be. In one approach, the binder material has a melt index that is less than 1.0 g/10 min as determined by ASTM D 1238 at 190° C. and 15 kg load.

A gravity-fed carbon block water filter according to yet another embodiment of the present invention includes about 20-90 wt % activated carbon particles; and about 5-50 wt % binder material, the binder material being interspersed with the activated carbon particles and coupled thereto such that a cavity is formed. A ratio of a surface area A (cm²) of the filter in contact with unfiltered water to a volume V (cm³) of the activated carbon particles, binder material, and any additional materials is greater than about 0.5 cm⁻¹. The water has an average flow rate of at least 0.1 liter per minute through the filter with a head pressure of between approximately 0.1 and 1.0 psi.

In one approach, the ratio is less than about 5. In another approach, the ratio is less than about 3.

Additional active materials may be present. In one approach, about 5-40 wt % of additional active material including a lead scavenger such as zirconia hydroxide may be present.

In a preferred embodiment, a lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter.

The binder material may be hydrophobic.

A gravity-flow system for filtering water according to an embodiment includes a container having a source water reservoir than can hold source water and a filtered water reservoir that can hold filtered water; a cartridge in communication with both the source water reservoir and the filtered water reservoir, the cartridge providing a path through which water can flow from the source water reservoir to the filtered water reservoir; and a filter as recited above disposed within the cartridge.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, reference should be made to the following detailed description read in conjunction with the accompanying drawings.

FIG. 1 is a cross-section, side elevation view of a pour-through carafe having a gravity-flow filtration cartridge with a carbon block filter installed therein.

FIG. 2 is a perspective view of one embodiment of a carbon block filter.

FIG. 3 is a top plan view of the carbon block filter shown in FIG. 2.

FIG. 4 is a top plan view of a carbon block filter having a filter sheet disposed proximate the inner wall.

FIG. 5 is a top plan view of a carbon block filter having a filter sheet disposed proximate the outer wall.

FIG. 6 is a top plan view of a carbon block filter having a first filter sheet disposed proximate the inner wall and a second filter sheet disposed proximate the outer wall.

FIG. 7 is a cross-section, side elevation view of an embodiment of a filtration cartridge with a carbon block filter installed therein.

FIG. 8 is a top plan view of the filtration cartridge cover shown in FIG. 7.

FIG. 9 is a bottom plan view of the filtration cartridge cup shown in FIG. 7.

FIG. 10 is a cross-section, side elevation view of an outward water flow path through the filtration cartridge assembly shown in FIG. 7.

FIG. 11 is a cross-section, side elevation view of an embodiment of a filtration cartridge having a carbon block filter installed therein.

FIG. 12 is a top plan view of the filtration cartridge cover shown in FIG. 11.

FIG. 13 is a bottom plan view of the filtration cartridge cup shown in FIG. 11.

FIG. 14 is a cross-section, side elevation view of an inward water flow path through the filtration cartridge shown in FIG. 11.

FIGS. 15A-D are various perspective, plan and cross-sectional views of another embodiment of a filter block according to another embodiment of the present invention.

### DETAILED DESCRIPTION OF THE INVENTION

Before describing the embodiments in detail, it is to be understood that this invention is not limited to particularly exemplified structures, systems or system parameters, as such may, of course, vary. It is also to be understood that the terminology used herein is for the purpose of describing particular embodiments of the invention only, and is not intended to be limiting.

### DEFINITIONS

In describing the embodiments of the present invention, the following terms will be employed, and are intended to be defined as indicated below.

The term “activated carbon,” as used herein, means highly porous carbon having a random or amorphous structure, and may have such additional or alternative properties as may be presented or implied from the discussion of activated carbon below.

The term “binder,” as used herein, means a material that promotes cohesion of aggregates or particles. Many binders may be used, for example, thermoplastic binder, thermo-set binder, etc. The term “binder” thus includes polymeric and/or thermoplastic materials that are capable of softening and becoming “tacky” at elevated temperatures and hardening when cooled. Such thermoplastic binders include, but are not limited to, end-capped polyacetals, such as poly(oxymethylene) or polyformaldehyde, poly(trichloroacetaldehyde), poly(n-valeraldehyde), poly(acetaldehyde), poly(propionaldehyde), and the like; acrylic polymers, such as polyacrylamide, poly(acrylic acid), poly(methacrylic acid), poly(ethyl acrylate), poly(methyl methacrylate), and the like; fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), poly(vinyl fluoride), and the like; polyamides, such as poly(6-aminocaproic acid) or poly(ε-caprolactam), poly(hexamethylene adipamide), poly(hexamethylene sebacamide), poly(11-aminoundecanoic acid), and the like; polyaramides, such as poly(imino-1,3-phenyleneiminoisophthaloyl) or poly(m-phenylene isophthalamide), and the like; parylenes, such as poly-p-xylylene, poly(chloro-p-xylylene), and the like; polyarylene oxides; polyarylates; polyaryl ethers, such as poly(oxy-2,6-dimethyl-1,4-phenylene) or poly(p-phenylene oxide), and the like; polysulfones; polyaryl sulfones, such as poly(oxy-1,4-phenylenesulfonyl-1,4-phenyleneoxy-1,4-phenylene-isopropylidene-1,4-phenylene), poly-(sulfonyl-1,4-phenyleneoxy-1,4-phenylenesulfonyl-4,4′-biphenylene), and the like; polycarbonates, such as poly(bisphenol A) or poly(carbonyldioxy-1,4-phenyleneisopropylidene-1,4-phenylene), and the like; polyesters, such as poly(ethylene terephthalate), poly(tetramethylene terephthalate), poly(cyclohexylene-1,4-dimethylene terephthalate) or poly(oxymethylene-1,4-cyclohexylenemethyleneoxyterephthaloyl), and the like; polyaryl sulfides, such as poly(p-phenylene sulfide) or poly(thio-1,4-phenylene), and the like; polyimides, such as poly(pyromellitimido-1,4-phenylene), and the like; polyolefins, such as polyethylene, polypropylene, poly(1-butene), poly(2-butene), poly(1-pentene), poly(2-pentene), poly(3-methyl-1-pentene), poly(4-methyl-1-pentene), and the like; vinyl polymers, such as poly(vinyl acetate), poly(vinylidene chloride), poly(vinyl chloride), polyvinlyl halides, polyvinyl esters, polyvinyl ethers, polyvinyl sulfates, polyvinyl phosphates, polyvinyl amines and the like; diene polymers, such as 1,2-poly-1,3-butadiene, 1,4-poly-1,3-butadiene, polyisoprene, polychloroprene, and the like; polystyrenes; copolymers of the foregoing, such as acrylonitrile-butadiene-styrene (ABS) copolymers, and the like; polyoxidiazoles; polytriazols; polycarbodiimides; phenol-formaldehyde resins; melamine-formaldehyde resins; formaldehydeureas; and the like; co-polymers and block interpolymers thereof; and derivatives and combinations thereof.

The thermoplastic binders further include ethylenevinyl acetate copolymers (EVA), ultra-high molecular weight polyethylene (UHMWPE), very high molecular weight polyethylene (VHMWPE), nylon, polyethers such as polyethersulfone, ethylene-acrylic acid copolymer, ethylene-methacrylic acid copolymer, ethylene-methylacrylate copolymer, polymethylmethacrylate, polyethylmethacrylate, polybutylmethacrylate, and copolymers/mixtures thereof.

The term “low melt index polymeric material,” as used herein, means a polymeric material having a melt index less than 1.8 g/10 min., as determined by ASTM D 1238 at 190° C. and 15 kg load. The term thus includes both ultra high and very high molecular weight polyethylene.

The term “colloidal lead” or “particulate lead” as used herein, means lead aggregates or compounds having a size greater than 0.1 μm in diameter. The term “soluble lead” as used herein means lead in ionic form or lead in aggregates or compounds smaller than 0.1 μm in diameter.

The terms “cationically charged” and “cationic,” as used herein, mean having a plurality of positively charged groups. The terms “cationically charged” and “positively charged” are thus synonymous and include, but are not limited to, a plurality of quaternary ammonium groups.

The term “functionalized,” as used herein, means including a plurality of functional groups (other than the cationic groups) that are capable of crosslinking when subjected to heat. Such functional groups include, but are not limited to, epoxy, ethylenimino and episulfido. The term “functionalized cationic polymer” thus means a polymer that contains a plurality of positively charged groups and a plurality of at least one further functional group that is capable of being crosslinked by the application of heat. Such polymers include, but are not limited to, epichlorohydrin-functionalized polyamines and epichlorohydrin-functionalized polyamido-amines.

The term “incorporating,” as used herein, means including, such as including a functional element of a device, apparatus or system. Incorporation in a device may be permanent, such as a non-removable filter cartridge in a disposable water filtration device, or temporary, such as a replaceable filter cartridge in a permanent or semi-permanent water filtration device.

Filter performance can be defined in various ways. For the purposes of the instant invention, good filter performance means some or all of the following:
Removal of at least 99.95% of particles greater than 3 μm in size from the source water until the water flow rate has been reduced by approximately 75% from an initial water flow rate;
Reduction of lead concentration to no more than 15 ppb in 80 gallons of source water that has an initial lead concentration of 150 ppb;
Reduction of colloidal lead from a solution containing 45 ppb of colloidal lead and 105 ppb of soluble lead. The effluent concentration of all forms of lead is reduced to less than 15 ppb.
Reduction of chloroform concentration to no more than 80 ppb in 80 gallons of source water that has an initial chloroform concentration of 450 ppb.
Reduction for all challenges is evaluated by measuring the given contaminant concentration in the effluent water collected throughout the testing lifetime of the filter at defined intervals, including but not limited to the initial effluent after filter conditioning, 50%, 100%, 180%, 200% of the claimed filter lifetime.

In general, water moves through gravity flow water filters with head pressures less than 1 pound per square inch (psi). Good flow rates for gravity flow water filters with head pressures in this range are rates faster than about 0.10 liters/min (or about 0.026 gallons/min), and preferably faster than about 0.20 liters/min (or about 0.05 gallons/min). In general, conventional, loose media, gravity-flow carbon filters have flow rates between about 0.125 liters/minute and 0.250 liters/minute. Heretofore known conventional carbon block filters vary in their flow rate performance and, as they are usually used only in faucet-mount systems, are subject to wider ranges of head pressure due to variations in household water pressures than are loose media filters. Typical carbon block filters can have flow rates around 3.5 liters/min (or about 0.75 gallons/min) with head pressures around 60 psi.

In general, flow rates of water through most block filters under the low pressure (less than 1 psi) conditions found in gravity flow systems is unacceptably slow.

As will be appreciated by one having ordinary skill in the art, the gravity flow filters described herein have many advantages.

In one embodiment, the filter, described by way of example below, generally contains approximately 20-90 wt % activated carbon particles having a mean particle size in the range of approximately 70-220 μm, and approximately 5-50 wt % low melt index polymeric material (i.e., binder). The low melt index polymeric material can have a melt index less than 1.8 g/10 min. as determined by ASTM D 1238 at 190° C. and 15 kg load and a mean particle size in the range of approximately 20-150 μm.

In another embodiment, the filter contains approximately 30-80 wt % activated carbon particles having a mean particle size in the range of approximately 70-90 μm, approximately 20-45 wt % low melt index polymeric material and approximately 5-40 wt % of an active material. The active material can contain ceramic particles, zeolite particles, zirconia, aluminosilicate, silica gel, alumina, metal oxides/hydroxides, inert particles, sand, surface charge-modified particles, clay, pyrolyzed ion-exchange resin, silver, zinc, and halogen based antimicrobial compounds, acid gas adsorbents, arsenic reduction materials, iodinated resins and mixtures thereof each having a mean particle size in the range of approximately 10-100 μm, or silica gel.

In yet another embodiment, a gravity-fed carbon block water filter includes activated carbon particles, a binder material interspersed with the activated carbon particles, and a lead scavenger coupled to at least one of the activated carbon particles and binder material, the lead scavenger being for removing lead from water. A total lead concentration (colloidal and soluble) in a liter of effluent water filtered by the carbon block is less than about 10 μg/liter throughout approximately 151 liters (40 gallons) of source water filtration, the source water having a pH of 8.5 and containing 135-165 parts per billion total lead with 30-60 ppb thereof being colloidal lead greater than 0.1 μm in diameter. The water has an average flow rate of at least 0.1 liter per minute through the filter with a head pressure of between approximately 0.1 and 1.0 psi.

In a further embodiment, a gravity-fed carbon block water filter includes activated carbon particles, and a binder material interspersed with the activated carbon particles, wherein the binder material has a melt index that is less than 1.8 g/10 min as determined by ASTM D 1238 at 190° C. and 15 kg load. In another embodiment, the binder material has a melt index that is less than 1.0 g/10 min as determined by ASTM D 1238 at 190° C. and 15 kg load. A structure of the block is characterized by having been compressed less than about 10% by volume during fabrication of the filter. A total lead concentration (colloidal and soluble) in a liter of effluent water filtered by the carbon block is less than about 10 μg/liter throughout approximately 151 liters (40 gallons) of source water filtration, the source water having a pH of 8.5 and containing 135-165 parts per billion total lead with 30-60 ppb thereof being colloidal lead greater than 0.1 μm in diameter. Water passing through the filter has an average flow rate of at least 0.1 liter per minute through the filter with a head pressure of between approximately 0.1 and 1.0 psi.

In a yet further embodiment, a gravity-fed carbon block water filter includes about 20-90 wt % activated carbon particles, and about 5-50 wt % binder material, the binder material being interspersed with the activated carbon particles and coupled thereto such that a cavity is formed. A ratio of a surface area A (cm²) of the filter in contact with unfiltered water to a volume V (cm³) of the activated carbon particles, binder material, and any additional materials is greater than about 0.5 cm⁻¹, wherein the water has an average flow rate of at least 0.1 liter per minute through the filter with a head pressure of between approximately 0.1 and 1.0 psi.

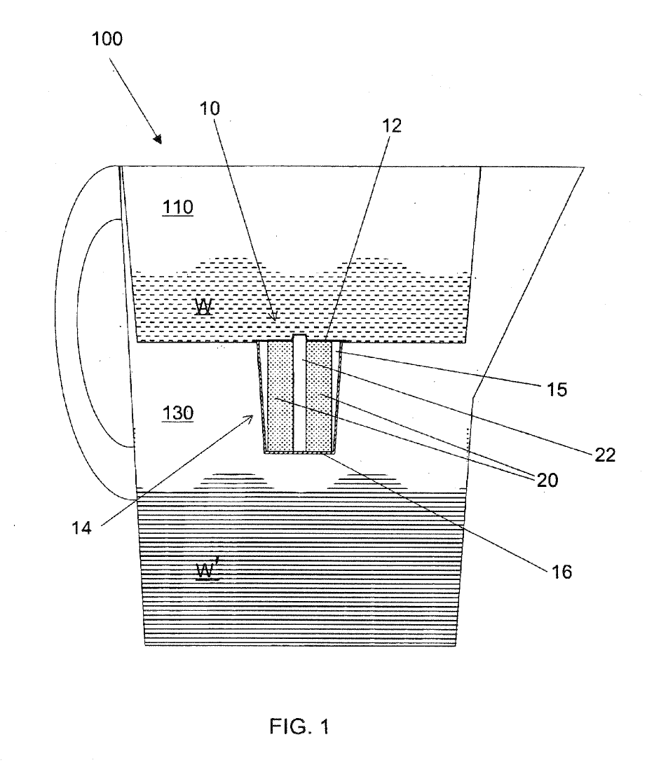

As alluded to, the aforementioned filters may be implemented in a gravity-flow system for filtering water. In general, a gravity-flow system for filtering water may include a container having a source water reservoir than can hold source water and a filtered water reservoir that can hold filtered water, a cartridge in communication with both the source water reservoir and the filtered water reservoir, the cartridge providing a path through which water can flow from the source water reservoir to the filtered water reservoir; and a carbon block filter as recited above disposed within the cartridge. An illustrative gravity-flow system for filtering water is shown in FIG. 1.

Referring first to FIG. 1, there is shown a filter cartridge 10 installed in a pour-through water carafe 100. The filter cartridge 10 has a carbon block filter 20 inside. In operation, source water W flowing from upper reservoir 110 to lower reservoir 130 is channeled through a plurality of openings (not shown) in cover 12, directly into interior space 15 of filter cup 14. Inorganic and organic contaminants are removed from the source water W, as the source water W moves through the filter 20, thus transforming the source water W into filtered water W′. The filtered water W′ flows into cavity 22 of the filter 20 and out through bottom 16 of the filter cup 14 into lower reservoir 130.

In an alternative embodiment, source water W flowing from the upper reservoir 110 to the lower reservoir 130 is channeled through a plurality of openings (not shown) in the cover 12, directly into the filter cavity 22. Inorganic and organic contaminants are removed from the source water W, as the source water W moves through the filter 20, thus transforming the source water W into filtered water W′. The filtered water W′ flows from the filter 20 directly out through the bottom 16 of the filter cup 14 and into the lower reservoir 130.

Although a pour-through carafe has been used to illustrate the filter 20, the filter 20 can be employed in combination with any water pitcher, bottle, carafe, tank, water cooler or other gravity-flow filtration system. The embodiments of the invention should thus not be construed as being limited in scope to filtering water only in pour-through carafes.

Further, multiple filters may be present in a single device, such as the aforementioned water pitcher, bottle, carafe, tank, water cooler or other gravity-flow filtration system. The filters may have the same construction, shape, and/or properties; or may be different. The filters may be arranged for concurrent flow (e.g., to increase filtering speed), and/or may filter the fluid in stages (e.g., one filter acts as a prefilter). Advantages of embodiments having two filters include increased flow rates, decreased frequency of filter changes, etc.

The filter 20 can contain activated carbon that is bonded with a binder to form an integrated, porous, composite, carbon block. The activated carbon can be in the form of particles or fibers. In some embodiments, the filter 20 includes at least one additional active material, such as ceramic or zeolite particles. The active material(s) can also be bound together with the carbon and the binder within the porous composite block.

### Activated Carbon

Activated carbon from any source can be used, such as that derived from bituminous coal or other forms of coal, or from pitch, bones, nut shells, coconut shells, corn husks, polyacrylonitrile (PAN) polymers, charred cellulosic fibers or materials, wood, and the like.

Activated carbon granules can, for example, be formed directly by activation of coal or other materials, or by grinding carbonaceous material to a fine powder, agglomerating it with pitch or other adhesives, and then converting the agglomerate to activated carbon. Different types of activated carbon can be used in combination or separately, e.g., 90% coconut carbon and 10% bituminous carbon.

In one embodiment of the invention, the mesh size of the activated carbon is approximately 80×325 U.S. mesh. Illustrative carbon particle size distributions are as follows:

80×325 PACO Carbon(d(0.1)=18.6 um, d(0.5)=87.1 um, d(0.9)=191.3 um)

80×325 PACO Carbon(d(0.1)=15.5 um, d(0.5)=73.8 um, d(0.9)=154.3 um)

In another embodiment of the invention, the mesh size of the activated carbon is approximately 80×200 U.S. mesh.

In yet another embodiment of the invention, the mesh size of the activated carbon is approximately 50×200 U.S. mesh.

In some arrangements, the activated carbon has an average particle size such that it can pass through a screen of 350 mesh or less (e.g., an average particle size of less than about 350 mesh-about 40 μm). In one arrangement, the activated carbon has a mean particle size in the range of 70-220 μm. In another arrangement, the activated carbon has a mean particle size in the range of 150-220 μm. In yet another arrangement, the activated carbon has a mean particle size in the range of 70-90 μm.

In another embodiment of the invention, the carbon content is in the range of approximately 10-90%, by weight. In an alternative embodiment, the carbon content is in the range of approximately 30-80%, by weight. In yet another embodiment, the carbon content is in the range of approximately 30-50% by weight.

The activated carbon can also be impregnated or coated with other materials to increase the adsorption of specific species. For example, the activated carbon can be impregnated with citric acid to increase the ability of the activated carbon to adsorb ammonia. Impregnation of the active carbon with hydroxides, such as sodium hydroxide, or other caustic compounds can also be useful for removal of hydrogen sulfide.

Impregnation of the activated carbon with metals, metal oxides, metal hydroxides or metal ions, such as copper sulfate and copper chloride, is believed to be useful for removal of other sulfur compounds. Finally, the activated carbon can also be impregnated with a variety of salts, such as zinc salts, potassium salts, sodium salts, silver salts, and the like. In other arrangements, activated carbon can be modified with reduced nitrogen groups, metal oxides, or other metal compounds suitable for removal of contaminants from water.

### Binder

The binder can contain any of the aforementioned binder materials. The binder can be a low melt index polymeric material, as described above. In other arrangements, the binder can contain a higher melt index material, that is, a material with a melt index that is greater than 1.8 g/10 min, as determined by ASTM D 1238 at 190° C. and 15 kg load. Preferred binders are also hydrophobic.

Low melt index polymeric materials having a melt index less than approximately 1.8 g/10 min as determined by ASTM D 1238 at 190° C. and 15 kg load, such as VHMWPE or UHMWPE, are well known in the art. Low melt index binders do not flow easily when heated, but become only tacky enough to bind granules together without covering much of the surface of the granules.

In some arrangements, binder materials that have high melt index values, that is, melt indices greater than those of VHMWPE or UHMWPE, such as poly(ethylene-co-acrylic acid) or low density polyethylene, can also be used. Even though high melt index materials can tend to melt and flow when heated, careful choice of binder particle size and processing conditions can make these materials very effective for forming porous composite blocks for water filtration. These binders and their use in water filtration have been disclosed by Taylor et al. in U.S. patent application Ser. No. 10/756,478, filed Jan. 12, 2004, which is included by reference herein.

As will be appreciated by one having ordinary skill in the art, the type of binder used to construct the filter 20 can affect the initial flow rate of water through the filter, since carbon is more hydrophilic than most binders or other actives. Initially, the filter 20 is dry and when it is placed in contact with water, it may or may not absorb the water readily and thus allow for immediate water flow. Filters made with UHMWPE or VHMWPE with a low melt index tend to absorb water more readily than filters made with EVA or LDPE. Also, by maximizing the available surface area of the carbon, one can achieve a carbon block that is hydrophilic and readily absorbs water. As a result, binders that neither flow nor deform significantly when melted, but simply become tacky, maximize the available carbon surface area and thus maximize the water absorptivity of the carbon block. Other binders that have a tendency to melt during processing can also provide a large available carbon surface area when they have very small particle sizes. As discussed in detail in the “Examples” section, this phenomenon has been confirmed by measuring the iodine number and strike-through of carbon blocks made with different binders.

In order to minimize the amount of carbon particle surface area covered/blocked by binder, especially-preferred binders comprise at least one binder having less than or equal to 10 g/min melt index, or, more preferably, 0.1-10 g/min melt index and especially 1-10 g/min melt index by ASTM D1238 or DIN 53735 at 190 degrees C. and 15 kilograms. Binders from these ranges may be selected that become tacky enough to bind the media particles together in a solid profile, but that maintain a high percentage of the media particle surface area uncovered/unblocked and available for effective filtration. Further, binders from these ranges may be selected that leave many interstitial spaces/passages open in the solid profile; in other words, it is desirable to have the binder not completely fill the gaps between media particles. With binders in these ranges, blocks have been made according to embodiments of the invention that have excellent pressure drop. It is believed that this excellent, low pressure drop results from the various block shapes and the porosity and high amount of interstitial spaces and passages through the solid profile. A high amount of porosity is desirable, and, when combined with the high amount of “bulk” surface area for the block (bulk surface area meaning the exposed surfaces of the block, including the cavities described above), the preferred embodiments are effective in delivering fluid to the media of the block, effective in fluid flow through the porous block, and effective in fluid flow out of the media in the block.

In one embodiment, the binder content is in the range of approximately 5-50%, by weight. In another embodiment, the binder content is in the range of approximately 20-45%, by weight. In yet another embodiment, the binder content is in the range of approximately 35-40% by weight.

In one embodiment of the invention, the binder particles are in the range of approximately 5-150 μm. In an alternative embodiment, the binder particles are in the range of approximately 100-150 μm. In another embodiment, the binder particles are approximately 110 μm.

### Actives

One or more additional active materials (or actives) can be included in the carbon block filter. The active(s) can contain ceramic particles, zeolite particles, zirconia, aluminosilicate, silica gel, alumina, metal oxides/hydroxides, inert particles, sand, surface charge-modified particles, clay, pyrolyzed ion-exchange resin, silver, zinc and halogen based antimicrobial compounds, acid gas adsorbents, arsenic reduction materials, iodinated resins, and mixtures thereof.

In one embodiment, the actives constitute between about 0.01 wt % and 70 wt % of the porous composite block. In other arrangements, the actives constitute between about 20 wt % and 40 wt % of the porous composite block. In another arrangement, the actives constitute between about 5% and 40%, by weight, of the porous composite block. In another arrangement, the actives constitute between about 10% and 30%, by weight, of the porous composite block. In further arrangements, the actives constitute between about 10 wt % and 40 wt % of the porous composite block. In yet another arrangement, the actives constitute between about 20% and 30%, by weight, of the porous composite block.

In one embodiment of the invention, the actives have a mean particle size in the range of approximately 10 to 100 μm. In another embodiment, the actives have a mean particle size in the range of approximately 20-70 μm. In an alternative embodiment, the actives have a mean particle size in the range of approximately 1 to 50 μm.

In yet another embodiment, actives include lead scavengers, e.g., lead sorbents, or arsenic removal additives. Illustrative lead scavengers include metal ion exchange zeolite sorbents such as Engelhard's ATS™ and activated aluminas such as Selecto Scientific's Alusil™. In one embodiment lead scavengers are zirconia oxides and hydroxides. In another embodiment the zirconia hydroxide is Isolux 302 M zirconia hydroxide, available from MEI, 500 Point Breeze Rd., Flemmington, N.J. 08822. Lead scavengers may be present in the amounts recited above for actives in general. In one embodiment, the range of lead scavenger content is about 5-40% by weight.

### Filter Block Dimensions

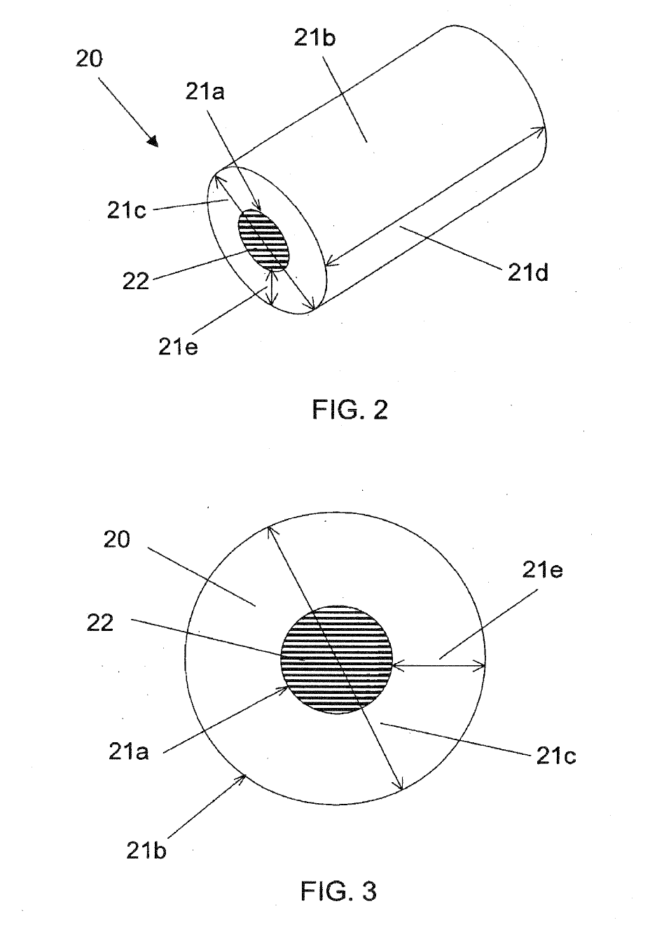

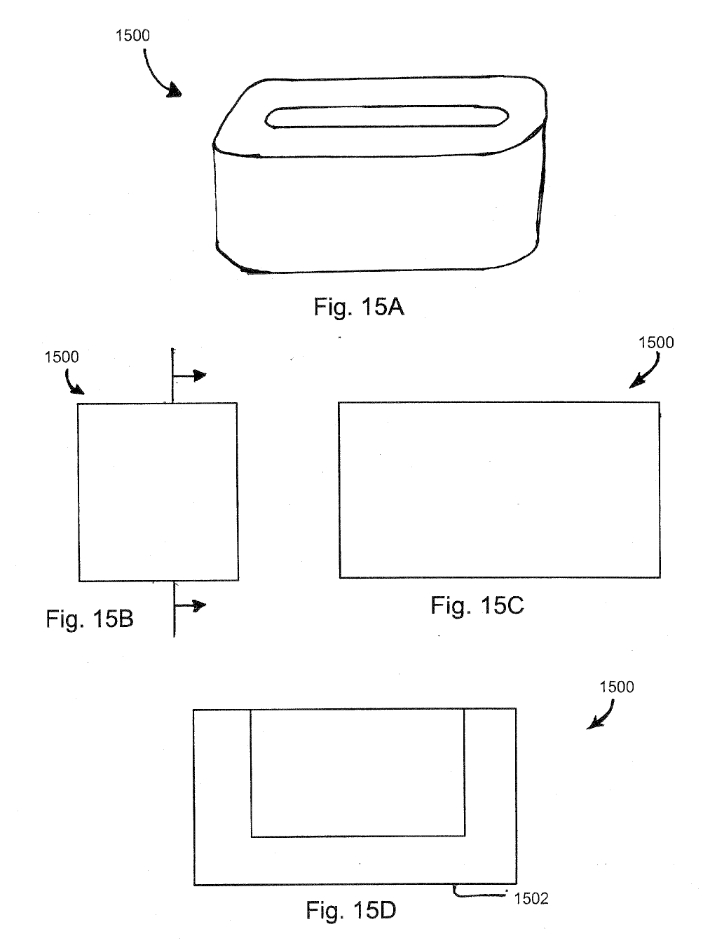

As illustrated in FIGS. 2 and 3, the porous composite block filter 20 can be substantially cylindrical in shape and can have an internal cavity or port 22. The filter 20 also has an internal surface 21a and an external surface 21b. External surface area of the filter 20 is the area of the cylindrical surface formed by external surface 21b. The filter 20 has an outside diameter 21c and a length 21d. Wall thickness 21e is the perpendicular distance between the internal surface 21a and the external surface 21b. Block filters can also have other shapes, such as sheets, solids, cubes, parallelepipeds, cups, etc. See, e.g., FIG. 15A.

Factors influencing the final dimensions of a filter block include the dimensions of the cartridge housing the filter block, desired properties and efficacy of the filter, etc.

The wall thickness 21e and the external surface 21b area of the carbon block filter can influence the flow rate of water through the filter. Good flow rates and effective contaminant removal can be achieved when the external surface 21b area is between approximately 9 in² and 46 in². In other arrangements, the external surface area can be in the range of approximately 18 in² to 30 in². In one embodiment, the wall thickness 21e is in the range of approximately 0.25 in to 0.75 in. In other arrangements, the wall thickness 21e is approximately 0.35 in to 0.60 in. The filter block 20 can have an outside diameter between about 2.0 in and 4.0 in., a length between about 1.0 in and 3.0 in. and a wall thickness between about 0.25 in and 0.75 in.

In one embodiment, the median wall thickness is in the range of approximately 0.15 in. to 0.60 in. In other arrangements, the wall thickness is less than about 0.40 in., e.g., approximately 0.20 in. to 0.40 in. The filter block can have an outside diameter between about 1.5 in. to 4.0 in., and a length between about 1.0 in. to 4.0 in.

### Filter Sheets

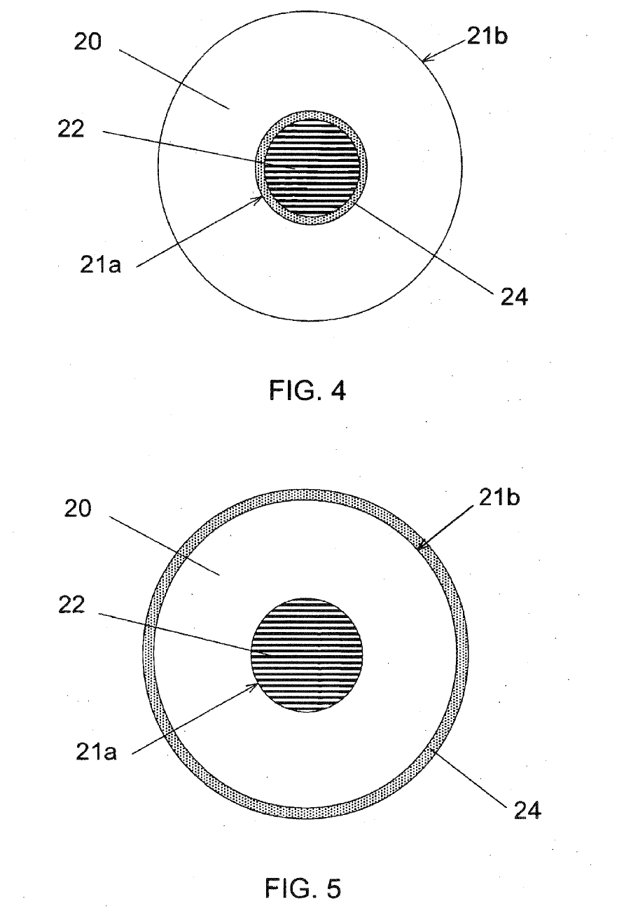

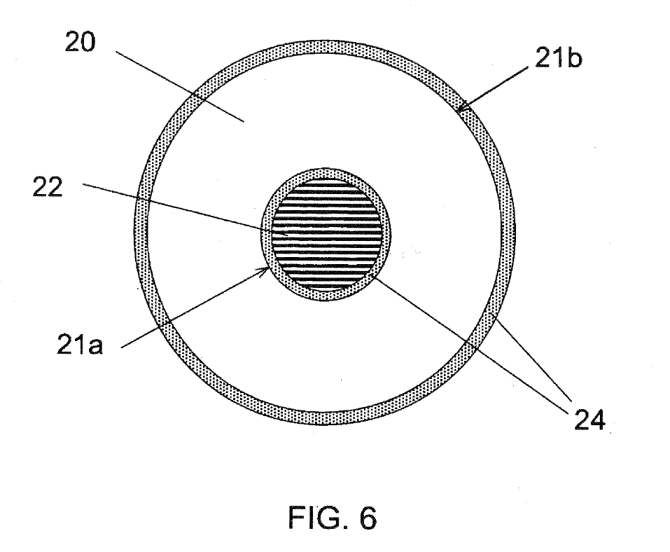

FIGS. 4, 5 and 6, show examples of how filter sheets can be used with a porous composite carbon block. In FIG. 4, a filter sheet 24 has been applied to the internal surface 21a of the block 20. In FIG. 5, a filter sheet 24 has been applied to the external surface 21b of the block 20. In FIG. 6, a filter sheet 24 has been applied to both the internal surface 21a and the external surface 21b of the block 20. The filter sheet 24 can enhance the performance and extend the life of the block filter 29. In one embodiment, for example, the filter sheet 24 is a non-woven material with a 1.0 μm pore size disposed on the internal and/or external surface of filter block to facilitate the removal of microbiological cysts, such as Giardia and Cryptosporidiumi. In another embodiment, the non-woven material is disposed on the outside surface of the filter block. The non-woven material can capture particles in the range of approximately 5-1.5 μm, thus preventing particles in this size range from clogging the internal porous structure of the carbon block. Use of woven and non-woven filter sheets on filter block surfaces can result in extended filter life. Non-woven materials used in conjunction with filter blocks have been disclosed in U.S. Pat. No. 5,980,743, which is included by reference herein.

The filter sheet can include a woven or non-woven sheet material. As used herein, the term “nonwoven sheet” means a web or fabric having a structure of individual fibers or threads which are interlaid, but not in an identifiable manner as in a knitted or woven fabric. Nonwoven sheets can be prepared by methods that are well known to those having ordinary skill in the art. Examples of such processes include meltblowing, coforming, spinbonding, carding and bonding, air laying, and wet laying.

The filter sheet can also include a nonwoven charge-modified material. As will be appreciated by one having ordinary skill in the art, a nonwoven charge-modified microfiber glass web can be prepared from a fibrous web that incorporates glass fibers having a cationically charged coating thereon. Generally, such microfibers would contain glass fibers having a diameter of about 10 μm or less. The coating typically includes a functionalized cationic polymer that has been crosslinked by heat, i.e., the functionalized cationic polymer has been crosslinked by heat after being coated onto the glass fibers. The coating can also contain a metal oxide or hydroxide.

A fibrous filter can be prepared by a method that includes the steps of providing a fibrous filter having glass fibers, passing a solution of a functionalized cationic polymer crosslinkable by heat through the fibrous filter under conditions sufficient to substantially coat the fibers with the functionalized cationic polymer, and treating the resulting coated fibrous filter with heat at a temperature and for a time sufficient to crosslink the functionalized cationic polymer present on the glass fibers. The functionalized cationic polymer can include an epichlorohydrin-functionalized polyamine or an epichlorohydrin-functionalized polyamido-amine.

When used as a filter medium, the charge-modified microfiber glass material can contain at least about 50 wt % of glass fibers, based on the weight of all fibers present in the filter media. In some embodiments, approximately 100% of the fibers contain glass fibers. When other fibers are present, however, they generally contain cellulosic fibers, i.e., fibers prepared from synthetic thermoplastic polymers, or mixtures thereof.

As indicated above, the terms “cationically charged,” in reference to a coating on a glass fiber, and “cationic,” in reference to the functionalized polymer, mean having a plurality of positively charged groups in the respective coating or polymer. Thus, the terms “cationically charged” and “positively charged” are deemed synonymous. Such positively charged groups include, but are not limited to, a plurality of quaternary ammonium groups.

The term “functionalized” means having a plurality of functional groups, other than the cationic groups, which are capable of crosslinking when subjected to heat. Examples of such functional groups include epoxy, ethylenimino, and episulfido. These functional groups readily react with other groups typically present in the cationic polymer. The “other groups” typically have at least one reactive hydrogen atom and are exemplified by amino, hydroxy, and thiol groups. As will be appreciated by one having ordinary skill in the art, the reaction of a functional group with another group often generates still other groups which are capable of reacting with functional groups. By way of example, the reaction of an epoxy group with an amino group results in the formation of a P-hydroxyamino group.

Thus, the term “functionalized cationic polymer” is meant to include any polymer which contains a plurality of positively charged groups and a plurality of other functional groups that are capable of being crosslinked by the application of heat. Particularly useful examples of such polymers are epichlorohydrin-functionalized polyamines and epichlorohydrin-functionalized polyamido-amines. Other suitable materials include cationically modified starches.

A nonwoven, charge-modified, meltblown material can contain hydrophobic polymer fibers, amphiphilic macromolecules adsorbed onto at least a portion of the surfaces of the hydrophobic polymer fibers, or a crosslinkable, functionalized cationic polymer associated with at least a portion of the amphiphilic macromolecules, in which the functionalized cationic polymer has been crosslinked. The crosslinking can be achieved through the use of a chemical crosslinking agent or by the application of heat.

Amphiphilic macromolecules can include one or more of the following types: proteins, poly(vinyl alcohol), monosaccha rides, disaccharides, polysaccharides, polyhydroxy compounds, polyamines, polylactones, and the like. In some arrangements, the amphiphilic macromolecules contain amphiphilic protein macromolecules, such as globular protein or random coil protein macromolecules. For example, in one embodiment of the invention, the amphiphilic protein macromolecules contain milk protein macromolecules.

Functionalized cationic polymers can contain a polymer that contains a plurality of positively charged groups and a plurality of other functional groups that are capable of being crosslinked by, for example, chemical crosslinking agents or the application of heat. Particularly useful examples of such polymers are epichlorohydrin-functionalized polyamines and epichlorohydrin-functionalized polyamido-amines. Other suitable materials include cationically modified starches.

Nonwoven charge-modified meltblown materials can be prepared by a method that involves providing a fibrous meltblown filter media having hydrophobic polymer fibers, passing a solution containing amphiphilic macromolecules through the fibrous filter under shear stress conditions so that at least a portion of the amphiphilic macromolecules are adsorbed onto at least some of the hydrophobic polymer fibers to give an amphiphilic macromolecule-coated fibrous web, passing a solution of a crosslinkable, functionalized cationic polymer through the amphiphilic macromolecule-coated fibrous web under conditions sufficient to incorporate the functionalized cationic polymer onto at least a portion of the amphiphilic macromolecules to give a functionalized cationic polymer-coated fibrous web in which the functionalized cationic polymer is associated with at least a portion of the amphiphilic macromolecules, and treating the resulting coated fibrous filter with a chemical crosslinking agent or heat. The coated fibrous filter can be treated with heat at a temperature and for a time sufficient to crosslink the functionalized cationic polymer.

### Processing

A carbon block filter can be manufactured using conventional manufacturing techniques and apparatus. In one embodiment, the binder, carbon granules, and other actives are mixed uniformly to form a substantially homogeneous blend. The blend is then fed into a mold having an inner surface conforming to the desired outer surface of the block filer, and that has an upwardly projecting member or members that define the cavity of the resultant block filter. In a cylindrical configuration, the blend is fed into a conventional cylindrical mold that has an upwardly projecting central dowel. The blend is heated to a desired temperature. In one embodiment, the binder is a low melt index polymeric material having a melt index less than approximately 1.8 g/10 min as determined by ASTM D 1238 at 190° C. and 15 kg load. In one embodiment the temperature is in the range of approximately 175-205° C. The optional compression may take place before heating, during heating, and/or after heating. Compression, if performed, is performed at a pressure of less than about 100 psi. After cooling, the resulting porous composite carbon block is removed from the mold and trimmed, if necessary.

As noted above, in the processing of the carbon block, compression can be applied in order to achieve a more consistent and stronger carbon block than can be achieved using a sintering process as commonly practiced in the porous plastics industry. Compression can facilitate good contact between powdered or granular media and binder particles by pressing the powdered media into the binder. Compression can also prevent cracking and shrinkage of the carbon block while the filter is cooling in the mold. Thus, in one embodiment of the invention, a compression that reduces the fill height of the mold in the range of approximately 0%-30% is employed. In some arrangements, the compression reduces the fill height of the mold in the range of approximately 5-20% or 10-20%. In other arrangements, the compression reduces the fill height of the mold by no more than approximately 10%. In yet another arrangement, no compression is applied.

### Filter Cartridge/Filter Assemblies

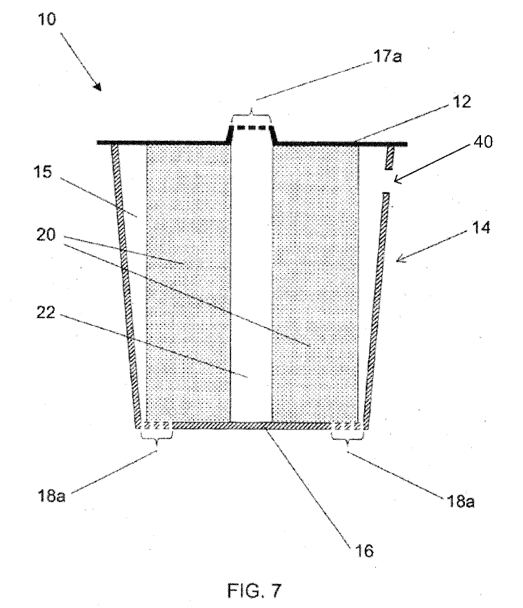

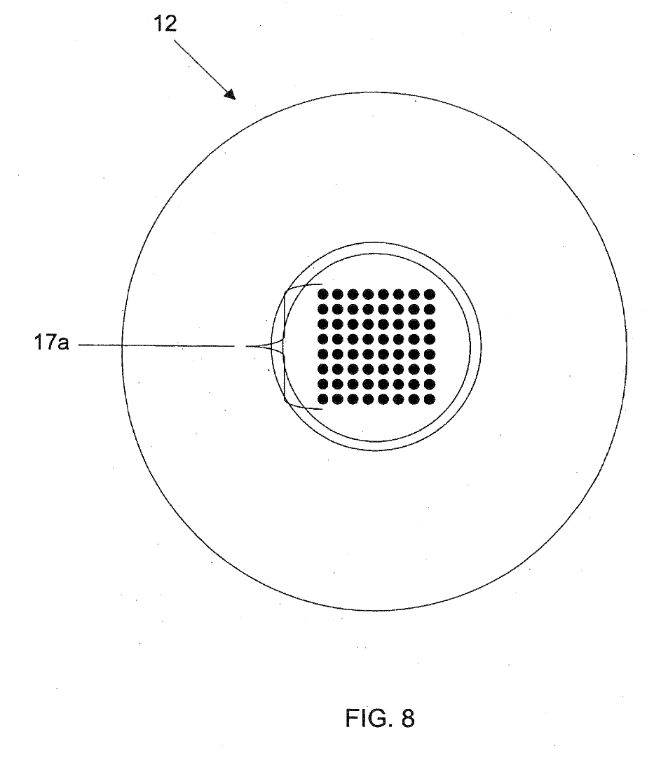

Cylindrical filters as illustrated in FIGS. 2-6 can be employed in most, if not all, gravity-flow filtration cartridges adapted to receive same. FIG. 7 is a schematic cross section of a filter housing or cartridge 10 that contains a porous composite carbon block filter 20, according to an embodiment of the invention. The cartridge includes a cover 12 and a cup 14. The cover 12 can be attached to the cup 14 after the filter 20 is placed inside the cup 14. Within the interior space of the cartridge 10 there is an outer space 15 outside the porous composite carbon block 20 and an inner space 22 within the bore of the porous composite carbon block 20. The cover 12 includes a plurality of entrance openings 17a near the center of the cover 12. The entrance openings 17a are adapted to allow water to enter into the inner space 22. The bottom 16 of the cup 14 includes a plurality of exit openings 18a. The exit openings 18a are adapted to allow water to exit from the outer space 15 and/or the porous composite carbon block 20. The cartridge may have an aperture 40 through a sidewall thereof for allowing at least egress of air into the treated water compartment.

FIG. 8 is a top view of the cover 12 of the filter cartridge 10 of FIG. 7, showing an exemplary embodiment of the invention. In this example, the entrance openings 17a are shown grouped near the center of the cover 12. Although the entrance openings 17a are shown as round holes arranged in a square array, it will be appreciated that other opening shapes, such a slots or slits and other arrangements of the openings, can be employed.

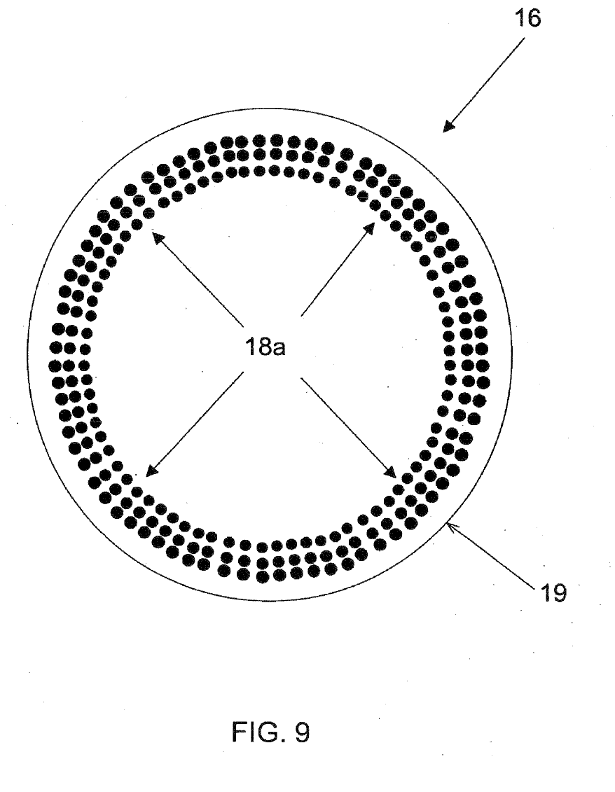

FIG. 9 is a bottom view of the cup 14 of the filter cartridge 10 of FIG. 7, showing an exemplary embodiment of the invention. In this arrangement, the exit openings are distributed in a circle concentric to an outer edge 19 of the cup bottom 16. Although the exit openings 18a are shown as round holes, it will be appreciated that other shapes, such a slots or slits, can be employed.

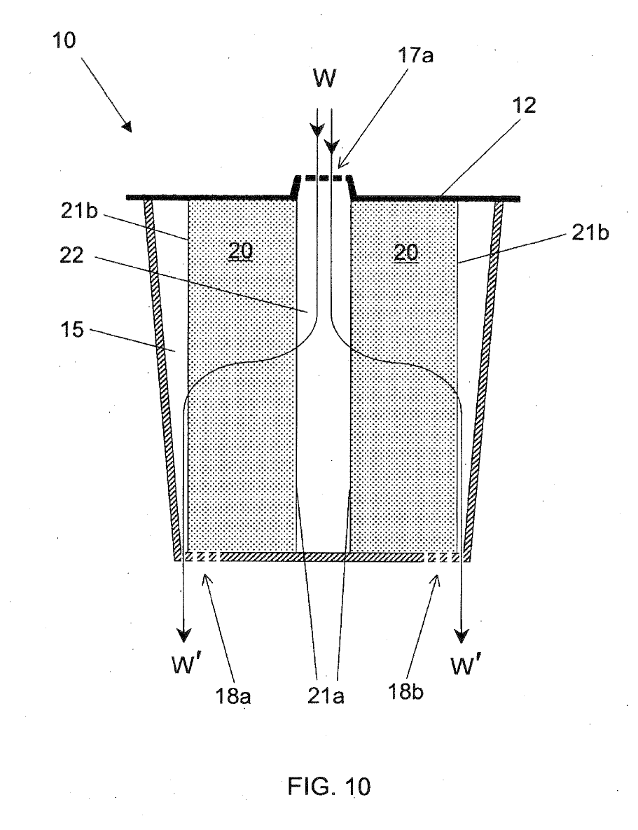

FIG. 10 is a schematic cross section showing a water flow path through the filter cartridge 10 and the carbon block filter 20. When the cap 12 is exposed to a body or flow of source water W, the source water W flows into and through the entrance openings 17a in the cap 12, and enters into the inner space 22 of the filter 20. The water W then flows through an interior wall 21a of the filter 20, out an exterior wall 21b of the filter 20, and into the outer space 15. In passing through the filter 20, the source water W becomes purified water W′. The purified water W′ exits the filter cartridge 10 through the exit openings 18a.

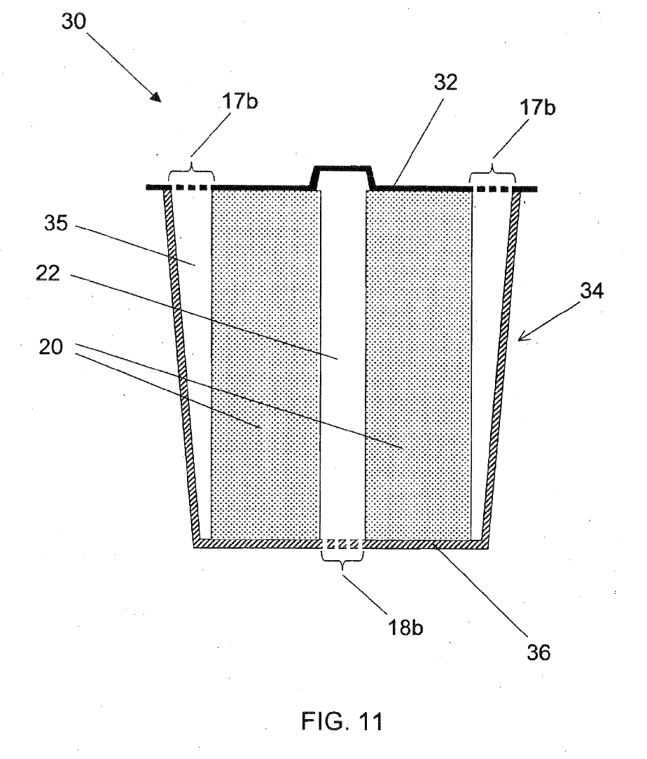

FIG. 11 is a schematic cross section of a filter housing or cartridge 30 that contains a porous composite carbon block filter 20, according to another embodiment of the invention. The cartridge includes a cover 32 and a cup 34. The cover 32 can be attached to the cup 34 after the filter 20 is placed inside the cup 34. Within the interior space of the cartridge 30 there is an outer space 35 outside the porous composite carbon block 20 and an inner space 22 within the bore of the porous composite carbon block 20. The cover 32 includes a plurality of entrance openings 17b near the periphery of the cover 32. The entrance openings 17b are adapted to allow water to enter into the inner space 22. The bottom 36 of the cup 34 includes a plurality of exit openings 18b. The exit openings 18b are adapted to allow water to exit from the inner space 22 and/or the porous composite carbon block 20.

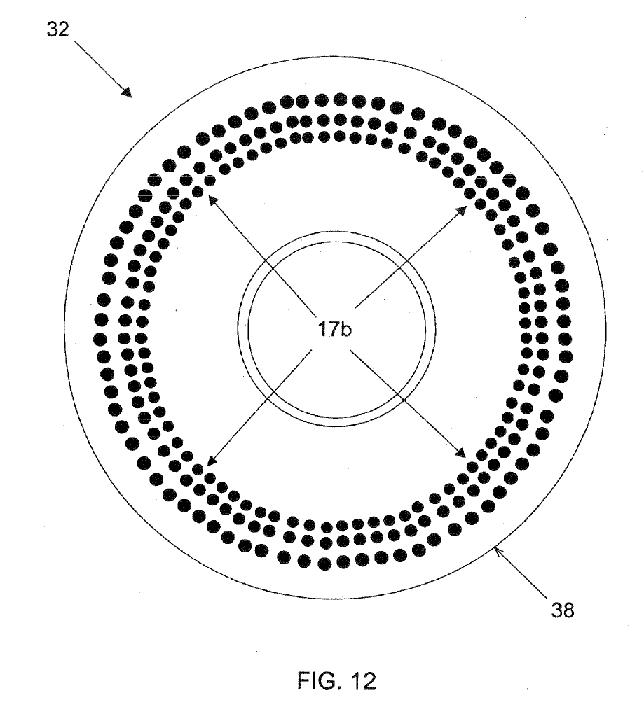

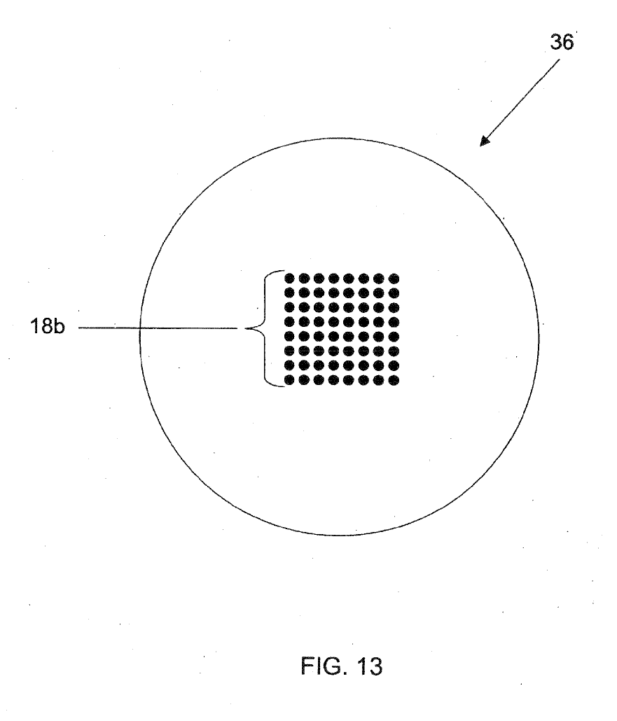

FIG. 12 is a top view of the cover 32 of the filter cartridge 30 of FIG. 11, showing an exemplary embodiment of the invention. In this arrangement, the entrance openings are distributed in a circle concentric with an outer edge 38 of the cover 32. Although the entrance openings 17b are shown as round holes arranged in a square array, it will be appreciated that other opening shapes, such as slots or slits and other arrangements of the openings, can be employed.

FIG. 13 is a bottom view of the cup 34 of the filter cartridge 30 of FIG. 11, showing an exemplary embodiment of the invention. In this example, the exit openings 18b are shown as grouped near the center of the cup bottom 36. Although the exit openings 18b are shown as round holes, it will be appreciated that other shapes, such a slots or slits, can be employed.

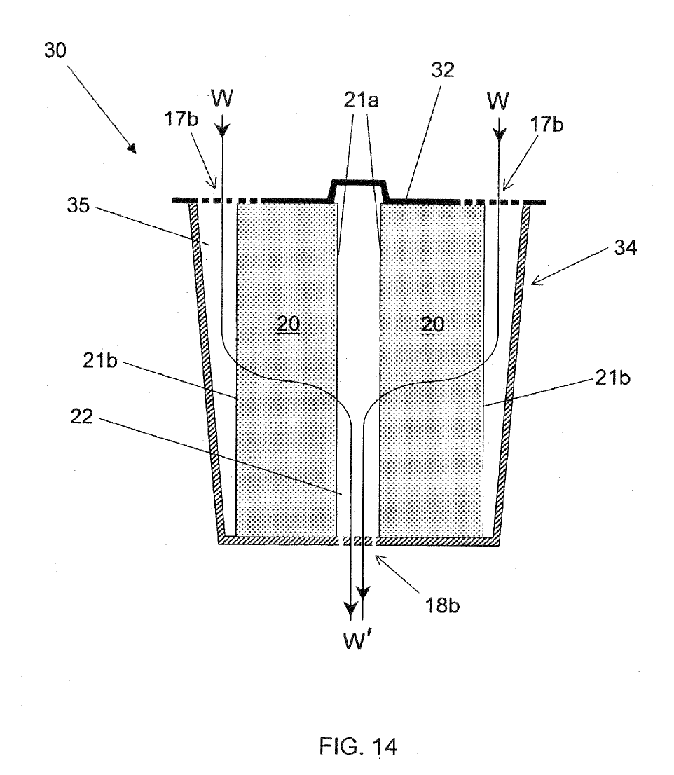

FIG. 14 is a schematic cross section showing a water flow path through the filter cartridge 30 and the carbon block filter 20. When the cap 32 is exposed to a body or flow of source water W, the source water W flows into and through the entrance openings 17b in the cap 32 and enters into the inner space 22 of the filter 20. The water W then flows through an exterior wall 21b of the filter 20, out an interior wall 21a of the filter 20, and into the inner space 22. In passing through the filter 20, the source water W becomes purified water W′. The purified water W′ exits the filter cartridge 30 through the exit openings 18b.

FIGS. 15A-D show an activated carbon block 1500 having a semi-cylindrical cup-shaped structure with closed bottom 1502. The block 1500 in FIGS. 15A-D may be formed to have a major (longest) outside diameter in the range of about 70 mm, preferably about 90 mm; a minor (shortest) outside diameter in the range of about 40 mm, preferably about 50 mm; a length in the range of about 20 mm, preferably about 55 mm; and a wall thickness in the range of about 0.20-0.75 inches. One may note that, in this cup-shaped block 1500, the interior surface/space substantially match the exterior surface; that is, the inner surface is a cup-shape and the outer surface is a cup-shape. The “Examples” section below describes several implementations of the block 1500.

### Performance

Other embodiments include filters for use in gravity flow or low pressure applications that meet a specific performance range of operation defined by filter volume, defined usage lifetime, average time of filtration, and/or lead reduction ability. The nature of the filter meeting the following performance criteria is independent of the exact embodiment of the filter and thus applicable to mixed-media, carbon blocks, non-wovens, hollow fibers and other filtration formats.

As noted above, a lead concentration in a final liter of effluent water filtered by some embodiments of a block filter is less than about 10 μg/liter after approximately 151 liters (40 gallons) of source water filtration, the source water having a pH of 8.5 and containing 135-165 parts per billion total lead with 30-60 ppb thereof being colloidal lead greater than 0.1 μm in diameter, fed in batches of about one liter with a head pressure of between approximately 0.1 and 1.0 psi.

Preferably, the source water is prepared as defined in the NSF/ANSI 53 protocol (2007). Illustrative source water specifications according to the NSF/ANSI 53 protocol (2007) are as follows:
135-165 ppb total lead content
20-40% of lead in colloidal form, size greater than 0.1 μm
greater than 20% of the colloidal lead must be in the 0.1 μm to 1.2 μm size range.
Hardness, alkalinity, chlorine content and pH of the water is specified as follows:

| Hardness | 90-110 mg/L |
|---|---|
| Alkalinity | 90-110 mg/L |
| Chlorine | 0.25-0.75 mg/L |
| PH | 8.3-8.6 |

Requirements and procedures of the NSF/ANSI 53 protocol are available in a document entitled “Drinking water treatment units—Health effects”, available from NSF International, 789 North Dixboro Road, P.O. Box 130140 Ann Arbor, Mich. 48113-0140, USA (Web: http://www.nsf.org), and which is herein incorporated by reference.

During testing, the source water is gravity-fed in batches of 1 liter. Preferably, the testing is performed in the container for which the subject filter is designed.

As apparent to those skilled in the art, it would be desirable to minimize the filter volume required to perform the lead removal specified in the previous paragraph. The filter volume (V) may be defined as the volume of filtering media or active media. This equates to the hydrated bed volume for mixed media filters and the mold volume for carbon block filters. Accordingly, while no specific filter volumes are required, preferred embodiments fall within the dimensions presented herein, the various volumes of filter media being readily discernible therefrom. In particularly preferred embodiments, the volume of the filter media (V) is less than about 300 cm³, and more preferably less than about 160 cm³.

Preferred embodiments also exhibit a high average filtration time. The average filtration unit time (f) is defined as the time it takes to filter one liter of water averaged over all filtered liters in the defined filter lifetime. In preferred embodiments, the average filtration unit time (f) is less than about 12 minutes per liter, and more preferably less than about 6 minutes per liter.

The filter usage lifetime (L) in some embodiments may be defined as the total number of gallons that can be effectively filtered according to claims presented by the manufacturer or seller of the filter. Typically these claims are present on the product packaging in the form of instructions to a consumer as to a quantity of water that can be filtered before the filter should be changed. The lifetime claims may also be presented in the manufacturer's or seller's advertising. Such claims typically bear some relationship to some performance attribute of the filter. Typically, filter usage lifetime claims require a substantiation process, and in some cases, a competitor may be able to challenge such claims in a judicial or non-judicial process.

Several gravity fed carbon blocks and mixed media filters have been tested for flow rate and lead reduction capability against the defined lead challenge water. Filters tested include several formulations of carbon blocks along with commercially available mixed media filters produced by BRITA® and PUR®. Based on the results from testing, the lead removal was calculated for each filter and reported below. No mixed media filters tested were able to reduce a total lead concentration in a final liter of effluent water to less than about 10 μg/liter after approximately 151 liters (40 gallons) of filtration of the specified lead challenge source water. The formulations of various embodiments of gravity fed carbon blocks disclosed herein are unique in their ability to reduce the total lead concentration in a final liter of effluent water to less than about 10 μg/liter after approximately 151 liters (40 gallons) of filtration of the specified lead challenge source water. The “Examples” below include many such embodiments. It is not believed that any currently-marketed gravity-flow filters are able to reduce a total lead concentration in a final liter of effluent water to less than about 10 μg/liter after approximately 151 liters (40 gallons) of filtration of the specified lead challenge source water.

### EXAMPLES

Embodiments of the present invention are further illustrated by the following examples. The examples are for illustrative purposes only and thus should not be construed as limitations in any way.

All scientific and technical terms employed in the examples have the same meanings as understood by one with ordinary skill in the art. Unless specified otherwise, all component or composition percentages are “by weight,” e.g., 30 wt %.

### Example 1

Two carbon block filters comprising approximately 80 wt % 80×200 mesh activated carbon (i.e., coconut shell carbon) and approximately 20 wt % binder were formed to investigate the water absorption characteristics of different binders. In filter #1, the binder was EVA. In filter #2, the binder was VHMWPE.

The degree to which carbon was available in each case to absorb impurities is indicated in the column labeled “percent available carbon.” This was determined by comparing the iodine number for the raw carbon to the iodine number for the bound carbon.

As will be appreciated by one having skill in the art, the iodine number is a number expressing the quantity of iodine absorbed by a substance. Referring now the Table I, the fourth column expresses the iodine number for the raw carbon. The fifth column expresses the iodine number for the carbon in its bound form, i.e., in a filter block. In each case, the filter block was first produced in accordance with the process described above, and then a portion thereof was ground up for purposes of determining its iodine number.

Conventional sodium thiosulfate titration techniques were used to determine the iodine number in each case. The percentage of available carbon is the bound carbon iodine number divided by the raw carbon iodine number multiplied by 100.

TABLE I

| | | | Iodine | | | Readily |
|---|---|---|---|---|---|---|
| Filter | Carbon | Iodine | No. of | No. of | Available | absorbs |
| Ref. | (C) | Binder | raw C | block | C | water? |
| #1 | ~80 wt % | ~20 wt % | 1016 | 633 | 62.3% | No |
| | | EVA | | | | |
| #2 | ~80 wt % | ~20 wt % | 1016 | 860 | 84.6% | Yes |
| | | VHMWPE | | | | |

As shown in Table I, the percentage of available carbon is significantly greater in filter #2 where the binder was a very high molecular weight, low melt index polymer. The noted results thus indicate that the use of a very high molecular weight, low melt index polymer can maximize the water absorptivity of carbon block filters employing same.

### Example 2

As is well known, a common measure of the absorbency of a material is called the “strike-through” value. The “strike-through” values are commonly employed in the absorbent article industry (e.g. diapers) to determine how fast a material absorbs water. Strike-through values were thus employed in the instant example to quantify the “wettability” of the carbon block filters. The method employed was as follows: a 1.0 in. internal diameter pipe section was glued to the surfaces of several carbon block filters so that approximately 0.785 in² of the block surface was exposed in the bottom of the pipe. A set quantity of water (i.e., 5.0 ml) was then introduced rapidly into the pipe section. Simultaneously with the introduction of the water, a timer was started. When the carbon block absorbed all the water, the timer was stopped and the absorption time recorded. The time to absorb the 5.0 ml of water was deemed the “strike-through” value for the respective carbon block filter.

Referring now to Table II, there is shown the strike-through data for several different carbon block filters.

TABLE II

| | Carbon | | | | Strike-Through |
|---|---|---|---|---|---|
| Filter Ref. | (Waterlink coconut) | Binder | Zeolite | Comp. | (seconds) |
| #3 | ~65 wt % 80 × 200 | ~20 wt % | ~15 wt % | 10% | 200 |
| | mesh | VHMWPE | | | |
| #4 | ~65 wt % 80 × 200 | ~20 wt % | ~15 wt % | 20% | 160 |
| | mesh | VHMWPE | | | |
| #5 | ~65 wt % 80 × 200 | ~20 wt % | ~15 wt % | 30% | 229 |
| | mesh | VHMWPE | | | |
| #6 | ~65 wt % 80 × 325 | ~20 wt % | ~15 wt % | 10% | 57 |
| | mesh | VHMWPE | | | |
| #7 | ~65 wt % 80 × 325 | ~20 wt % | ~15 wt % | 20% | 74 |
| | mesh | VHMWPE | | | |
| #8 | ~65 wt % 80 × 325 | ~20 wt % | ~15 wt % | 20% | >2000 |
| | mesh | EVA | | | |

As reflected in the data set forth in Table II, filter #3, having the 80×200 mesh activated carbon, had a significantly higher strike-through value (200 sec) as compared to filter #6, having a 80×325 mesh carbon. Filter #6 was thus deemed more “wettable” than filter #3.

The strike-through value for filter #8, having an EVA binder, was also significantly greater than filters #3-#7, which have the VHMWPE binder. Filters #3-#7 were thus more wettable than filter #8.

The noted strike-through data further indicate that carbon block filters having fine carbon particle sizes and subjected to low compression exhibit greater wettability than those that have a more coarse carbon particle size and higher compression. Further, carbon block filters having high molecular weight binders, such as VHMWPE, provide significantly greater wettability as compared to an EVA binder.

It should be noted that filters that do not absorb water readily (e.g., filter #8) can still provide the benefits of fast flow and high contaminant reduction. In order to get such a filter to absorb water and begin flowing, initially water can be forced through the carbon block under pressures of 1 to 10 psi to wet the internal surfaces of the block. After the pressure conditioning step, the filters can flow just as fast as filters that have a low “strike-through” value. The noted conditioning step can be performed at the manufacturing facility and the filter sealed into a water tight bag or it can be performed by the consumer with a special adapter to connect the filter to a standard household faucet.

### Example 3

The porosity of the carbon block filter is also critical in the performance and flow rate of the carbon block filters. The porosity of the finished carbon block is determined mainly by the particle sizes of the raw materials and by the amount of compression exerted on the block during the manufacturing process. As discussed below, smaller particles and higher compression can each result in lower porosity.

In order to investigate the porosity of the carbon block filters, carbon block filters of approximately 65 wt % activated carbon, 20 wt % EVA or VHMWPE binders and 15 wt % zeolite were prepared in accordance with procedures described herein.

Referring to Table III, porosity data for the noted filters are shown. The median pore diameter was determined by mercury porosimetry.

TABLE III

| | | | | | Vol. Median | |
|---|---|---|---|---|---|---|
| | | | | | Filter | |
| | | | | | Pore Dia. | Flow Rate |
| Filter Ref. | Carbon | Binder | Zeolite | Comp. | (μm) | (liter/min) |
| #9 | ~65 wt % | ~20 wt % | ~15 wt % | 20% | 45.39 | 0.6 |
| | 80 × 200 | EVA | | | | |
| | mesh | | | | | |
| #10 | ~65 wt % | ~20 wt % | ~15 wt % | 20% | 12.04 | 0.13 |
| | 80 × 325 | EVA | | | | |
| | mesh | | | | | |
| #11 | ~65 wt. % | ~20 wt % | ~15 wt % | 20% | 26.00 | 0.70 |
| | 80 × 200 | VHMWPE | | | | |
| | mesh | | | | | |
| #12 | ~65 wt. % | ~20 wt % | ~15 wt. % | 20% | 9.01 | 0.21 |
| | 80 × 325 | VHMWPE | | | | |
| | mesh | | | | | |

The porosity data indicate that, for a given binder, the larger the volume median pore diameter, the higher the resulting flow rate of the filter. It should be noted that filter #11 had a higher flow rate than filter #9 and filter #12 had a higher flow rate than filter #10. These respective filter sets had identical filter formulations and compression but different binder types. Therefore, it can reasonably be concluded that higher flow rates can be achieved with a VHMWPE binder than with an EVA binder.

Furthermore, filters #11 and #12 had smaller volume median pore diameters than filters #9 and #10, respectively. However, the flow rates of filters #11 and #12 were still higher than #9 and #10, respectively.

Thus, a balance between volume median pore diameter and binder can (and should) be achieved to realize gravity flow rates between about 0.125 and 0.250 liters/minute.

### Example 4

Three carbon block filters were formed in accordance with procedures described herein. Each filter had an outside diameter of 2.75 inches, a wall thickness of 0.42 inches, and a length of 3.0 in. The composition of each filter was ˜65 wt % 80×200 mesh activated carbon, 20 wt % EVA binder and 15 wt % zeolite. The compression employed was approximately 20%.

Each carbon block filter was assembled into a filtration cartridge having an “inward flow” configuration, as shown in FIGS. 11-14. The filters were then tested for chlorine, lead—pH8.5 and VOC's to 300 liters in a carafe system in accordance with NSF standards 42 and 53. The results of the tests are set forth in Table IV.

TABLE IV

| | Head | | Cl | Pb | VOC |
|---|---|---|---|---|---|
| | Pressure | Flow rate | reduction | reduction | reduction |
| Filter Ref. | (psi) | (liter/min.) | (%) | (%) | (%) |
| #13 | 0.15 | 0.65 | >98% | | |
| #14 | 0.15 | 1.1 | | 99% | |
| #15 | 0.15 | 0.60 | | | 99% |

The data set forth in Table IV shows that filters #13-#15 exhibited superior filtration performance, removing virtually all of the chlorine, lead and VOC's, respectively, to 300 liter. The flow rates for the noted filters were also 3-5 times greater than conventional gravity flow filters.

### Example 5

Three similarly dimensioned gravity flow carbon block filters having about 68 wt % 80×200 mesh activated carbon, 22 wt % VHMWPE binder and 10 wt % zeolite were formed in accordance with procedures described herein.

Each carbon block filter was assembled into a filtration cartridge, as shown in FIGS. 11-14, having an “inward flow” configuration. The filters were then tested in a carafe system in accordance with NSF standards 42 and 53 for chlorine, lead pH8.5 and VOC's to 300 liters. The results of the tests are set forth in Table V.

TABLE V

| | Head | | Cl | Pb | VOC |
|---|---|---|---|---|---|
| | Pressure | Flow rate | reduction | reduction | reduction |
| Filter Ref. | (psi) | (liter/min) | (%) | (%) | (%) |
| #16 | 0.15 | 0.85 | >98% | — | — |
| #17 | 0.15 | 0.90 | — | 99% | — |
| #18 | 0.15 | 0.95 | — | — | 99% |

The results indicate that using a VHMWPE binder instead of an EVA binder yields higher average flow rates, while not affecting the contaminant removal capability of the filter.

### Example 6

A similarly dimensioned gravity flow carbon block filter having the following composition was formed: about 68 wt % 80×200 mesh activated carbon, 22 wt % VHMWPE binder and 10 wt % zeolite.

The carbon block filter was initially assembled into a filtration cartridge having an “inward flow configuration,” as illustrated in FIGS. 11-14. The filter was then tested in a carafe system with an initial head pressure of 0.15 psi to assess the water flow rate.

The same carbon block filter was then assembled into a filtration cartridge having an “outward flow configuration,” as illustrated in FIGS. 7-10. The filter was then similarly tested in a carafe system with an initial head pressure of 0.15 psi. to assess the water flow rate.

The results of this comparative study are shown in Table VI.

TABLE VI

| Cartridge Type | Flow Rate (liter/min) |
|---|---|
| Inward flow configuration | 1.1 |
| Outward flow configuration | 0.85 |

The data clearly reflects that the flow rate of the inward flow configuration is significantly faster than the flow rate of the outward flow configuration.

### Examples 7A-D

Gravity fed carbon blocks were formulated in cup-shaped blocks having a shape as shown in FIGS. 15A-D. The blocks shapes provide large surface areas in the given volumes. The blocks are comprised of activated carbon in powder or fiber form, low melt flow high molecular weight binder, and a lead sorbent material.

The cup-shaped blocks in this example each have a volume of 105 cm³ with an internal surface area of 60.6 cm³ (surface area in contact with unfiltered water available for water flow, does not include top surface). The mass of the cup-shaped blocks tested ranged from 35 g for the fiber blocks to 43.5 g for the powder blocks.

The cup-shaped blocks were evaluated for flow rate performance and lead reduction performance against colloidal lead challenged water prepared as defined in NSF/ANSI 53 Protocol (2007). In addition to testing the gravity fed carbon blocks, several mixed media filters, containing granular activated carbon and ion exchange resin, were tested for comparative performance.

Table VII lists some of the formulations used in the following examples.

TABLE VII

| Filter | Lead | | | | | |
|---|---|---|---|---|---|---|
| Cup-Shaped | Sorbent | | % Lead | % | | Fill |
| (FIGS. 15A-D): | Type | Carbon Type | Sorbent | Carbon | % Binder | Weight |
| FA1-1 | Alusil ™¹ | Fiber Type 3² | 10 | 50 | 40 | 38.0 |
| FA1-3 | Alusil | Fiber Type 3 | 10 | 50 | 40 | 38.0 |
| FA2-3 | Alusil | Fiber Type 3 | 15 | 45 | 40 | 38.0 |
| FA2-4 | Alusil | Fiber Type 3 | 15 | 45 | 40 | 38.0 |
| FA3-2 | Alusil | Fiber Type 3 | 20 | 40 | 40 | 38.0 |
| FT2-1 | ATS³ | Fiber Type 3 | 10 | 50 | 40 | 38.0 |
| FT2-3 | ATS | Fiber Type 3 | 10 | 50 | 40 | 38.0 |
| PA1-1 | Alusil | PACO⁴ | 10 | 50 | 40 | 44.0 |
| PA1-2 | Alusil | PACO | 10 | 40 | 40 | 44.0 |
| PA2-1 | Alusil | PACO | 15 | 45 | 40 | 44.0 |
| PA2-2 | Alusil | PACO | 15 | 45 | 40 | 44.0 |
| PA2-3 | Alusil | PACO | 15 | 45 | 40 | 44.0 |
| PA3-2 | Alusil | PACO | 20 | 40 | 40 | 44.0 |
| PA3-3 | Alusil | PACO | 20 | 40 | 40 | 44.0 |
| PT2-1 | ATS | PACO | 10 | 50 | 40 | 44.0 |
| PT2-2 | ATS | PACO | 10 | 50 | 40 | 44.0 |
| PT2-3 | ATS | PACO | 10 | 50 | 40 | 44.0 |

¹Alusil - Selecto Scientific, Inc. 3980 Lakefield Court, Suwanee, GA 30024 - Sodium Alumina Slicate lead sorbent with 40-70 μm diameter.
²Fiber type 3 - CarboPur Technologies, 1744 William St. Suite 109, Montreal, Quebec, Canada H3J1R4 - Activated carbon fiber from synthetic source mechanically ground to smaller size.
³ATS - Engelhard Corporation, 101 Wood Ave., Iselin, NJ 08830 - Titanium Silicate zeolite lead sorbent with 25-30 μm diameter.
⁴PACO - Pacific Activated Carbon Company - activated coconut shell carbon with 80 × 325 mesh size.

### Example 7A

Cup-shaped blocks formulated with activated carbon fiber in varying ratios with lead sorbent and 40% GUR™ 2122 binder were tested for their removal of lead from colloidal lead challenged water as defined in the NSF/ANSI 53 Protocol (2007). Referring to Table VIII below, the FA1 blocks contained 40 wt. % binder, 50 wt. % activated carbon fiber (ground Type 3 fiber from Carbopure), and 10 wt. % Alusil™ lead sorbent. FA2 blocks contained 40 wt. % binder, 45 wt. % activated carbon fiber, and 15 wt. % Alusil™ lead sorbent. FA3 blocks contained 40 wt. % binder, 40 wt. % activated carbon fiber, and 20 wt. % Alusil™ lead sorbent. FT2 blocks contained 40 wt. % binder, 50 wt. % activated carbon fiber, and 10 wt. % ATS lead sorbent.

Lead challenged water was formulated with 150 ppb lead with 45 ppb in colloidal form (size>0.1 microns). The colloidal lead is a challenge for gravity fed filters to remove whilst maintaining rapid filtrations rates (<7 min./liter). The flow rates were measured by filling a liter reservoir of a standard Brita® pitcher with the lead challenged water. The time required for the water to filter through the filtration material was recorded and the resulting effluent water was tested as indicated in Table 2. The filtrate effluents were collected after 3, 76, 151, 227, 273, and 303 liters of challenged water had been filtered. This corresponds to 2, 50, 100, 150, 180, and 200% of filter life. The total lead concentrations reported includes both colloidal and particulate form. The lead concentration was measured using an atomic adsorption spectrometer. The concentration of lead in the effluent and influent (challenge) water are displayed in ppb. Effluent values less than 10 ppb are desirable

TABLE VIII

| Liters Filtered | 3 L | 76 L | 151 L | 227 L | 273 L | 303 L | average |
|---|---|---|---|---|---|---|---|
| FA 1-1 | | | | | | | |
| Effluent Total Pb Conc. (ppb) | 6.14 | 5.36 | 6.86 | 15.14 | 18.6 | 18.57 | 11.8 |
| Influent Total Pb Conc. (ppb) | 171.9 | 143 | 141.9 | 149.5 | 146.2 | 150.4 | 150.5 |
| % Total Pb Removed | 96.4 | 96.3 | 95.2 | 89.9 | 87.3 | 87.7 | |
| Flow Rate (min/liter) | 3:25 | 3:25 | 3:30 | 4:26 | 4:21 | 4:18 | 0:03:44 |
| FA 1-3 | | | | | | | |
| Effluent Total Pb Conc. (ppb) | 11.94 | 14.58 | 17.31 | 18.29 | 12.1 | 14.07 | 14.7 |
| Influent Total Pb Conc. (ppb) | 154.1 | 135.9 | 145.9 | 142.1 | 146.5 | 145.8 | 145.1 |
| % Total Pb Removed | 92.3 | 89.3 | 88.1 | 87.1 | 91.7 | 90.3 | |
| Flow Rate (min/liter) | 3:45 | 3:37 | 3:35 | 3:32 | 3:36 | 3:36 | 0:03:36 |
| FA 2-3 | | | | | | | |
| Effluent Total Pb Conc. (ppb) | 5.58 | 5.23 | 6.92 | 15.05 | 17.42 | 19.14 | 11.6 |
| Influent Total Pb Conc. (ppb) | 152.9 | 150.2 | 142.4 | 145.5 | 148.1 | 147.8 | 147.8 |
| % Total Pb Removed | 96.4 | 96.5 | 95.1 | 89.7 | 88.2 | 87.1 | |
| Flow Rate (min/liter) | 3:24 | 3:21 | 3:26 | 4:23 | 4:17 | 4:09 | 0:03:41 |
| FA 2-4 | | | | | | | |
| Effluent Total Pb Conc. (ppb) | 13.13 | 17.67 | 20.29 | 20.66 | 16.88 | 18.32 | 17.8 |
| Influent Total Pb Conc. (ppb) | 151.3 | 132.52 | 132.3 | 152 | 146.4 | 147.4 | 143.7 |
| % Total Pb Removed | 91.3 | 86.7 | 84.7 | 86.4 | 88.5 | 87.6 | |
| Flow Rate (min/liter) | 2:54 | 2:34 | 2:30 | 2:32 | 2:29 | 2:30 | 0:02:32 |
| FA 3-2 | | | | | | | |
| Effluent Total Pb Conc. (ppb) | 4.21 | 5.1 | 6.9 | 13.24 | 16.82 | 36.59 | 13.81 |
| Influent Total Pb Conc. (ppb) | 155 | 143.6 | 143.6 | 159.4 | 151.9 | 147.4 | 150.2 |
| % Total Pb Removed | 97.3 | 96.4 | 95.2 | 91.7 | 88.9 | 75.2 | |
| Flow Rate (min/liter) | 3:04 | 2:58 | 3:03 | 4:51 | 4:40 | 4:37 | 0:03:33 |
| FA 3-3 | | | | | | | |
| Effluent Total Pb Conc. (ppb) | 10.82 | 15.67 | — | 19.61 | 14.06 | 10.52 | 14.1 |
| Influent Total Pb Conc. (ppb) | 150.7 | 149.6 | — | 148.5 | 145.6 | 145.3 | 147.9 |
| % Total Pb Removed | 92.8 | 89.5 | — | 86.8 | 90.3 | 92.8 | |
| Flow Rate (min/liter) | 3:38 | 3:11 | 3:06 | 2:54 | 3:01 | 2:59 | 0:03:07 |
| FT 2-1 | | | | | | | |
| Effluent Total Pb Conc. (ppb) | 6.6 | 5.97 | 7.76 | 9.25 | 20.6 | 18.19 | 11.4 |
| Influent Total Pb Conc. (ppb) | 151.3 | 154 | 140.1 | 137 | 144.48 | 150.4 | 146.2 |
| % Total Pb Removed | 95.6 | 96.1 | 94.5 | 93.2 | 85.7 | 87.9 | |
| Flow Rate (min/liter) | 2:54 | 2:51 | 2:53 | 3:49 | 3:46 | 3:45 | 0:03:11 |
| FT 2-3 | | | | | | | |
| Effluent Total Pb Conc. (ppb) | 4.38 | 14.8 | 17.36 | 17.78 | 13.09 | 14.11 | 13.6 |
| Influent Total Pb Conc. (ppb) | 148.9 | 130.7 | 132.9 | 128 | 146.4 | 167.4 | 142.4 |
| % Total Pb Removed | 97.1 | 88.7 | 86.9 | 86.1 | 91.1 | 91.6 | |
| Flow Rate (min/liter) | 3:34 | 2:55 | 2:50 | 2:46 | 2:30 | 2:31 | 0:02:47 |

The cup-shaped fiber blocks exhibit extremely fast flow rates (<4 min./liter) with several blocks reducing lead levels to below 10 ppb over the lifespan of the filter (151 liters).

### Example 7B

Cup-shaped blocks formulated with powder carbon fiber in varying ratios with lead sorbent and 40% GUR™ 2122 binder were tested by the method described in Example 7A. The results are shown in Table IX. PA1 blocks contained 40 wt. % binder, 50 wt. % powder carbon fiber (HMM 80×320), and 10 wt. % Alusil™ lead sorbent. PA2 blocks contained 40 wt. % binder, 45 wt. % powder carbon fiber, and 15 wt. % Alusil™ lead sorbent. PA3 blocks contained 40 wt. % binder, 40 wt. % powder carbon fiber, and 20 wt. % Alusil™ lead sorbent. PT2 blocks contained 40 wt. % binder, 50 wt. % powder carbon fiber, and 10 wt. % ATS lead sorbent.

TABLE IX

| Liters Filtered | 3 L | 76 L | 151 L | 227 L | 273 L | 303 L | average |
|---|---|---|---|---|---|---|---|
| PA 1-1 | | | | | | | |
| Effluent Total Pb Conc. (ppb) | 0.91 | 1.68 | 3.39 | 5.01 | 14.03 | 15.88 | 6.8 |
| Influent Total Pb Conc. (ppb) | 146.1 | 144.7 | 141.4 | 159.8 | 138.3 | 137.2 | 144.6 |
| % Total Pb Removed | 99.4 | 98.8 | 97.6 | 96.9 | 89.9 | 88.4 | |
| Flow Rate (min/liter) | 12:27 | 9:42 | 9:40 | 9:44 | 10:07 | 9:55 | 0:09:52 |
| PA 1-2 | | | | | | | |
| Effluent Total Pb Conc. (ppb) | 1.43 | 2.83 | 3.87 | 2.67 | 4.48 | 4 | 3.2 |
| Influent Total Pb Conc. (ppb) | 161.6 | 135 | 130.7 | 160.4 | 142.2 | 173.3 | 150.5 |
| % Total Pb Removed | 99.1 | 97.9 | 97.0 | 98.3 | 96.8 | 97.7 | |
| Flow Rate (min/liter) | 12:55 | 12:14 | 9:57 | 10:04 | 9:41 | 9:21 | 0:10:35 |
| PA 2-1 | | | | | | | |
| Effluent Total Pb Conc. (ppb) | 0.96 | 1.43 | 3.13 | 10.77 | 13.79 | 14.89 | 7.5 |
| Influent Total Pb Conc. (ppb) | 154.6 | 153.1 | 152 | 158.2 | 138.6 | 139.6 | 149.4 |
| % Total Pb Removed | 99.4 | 99.1 | 97.9 | 93.2 | 90.1 | 89.3 | |
| Flow Rate (min/liter) | 10:50 | 9:45 | 9:50 | 9:47 | 10:12 | 10:16 | 0:08:07 |
| PA2-2 | | | | | | | |
| Effluent Total Pb Conc. (ppb) | 3.34 | 7.49 | 2.05 | 4.92 | 7.1 | 8.45 | 5.6 |
| Influent Total Pb Conc. (ppb) | 155.2 | 153.6 | 135 | 139.7 | 130.4 | 132.8 | 141.1 |
| Influent Sol. Pb Con. (ppb) | 109.3 | 107.5 | | 91.7 | 93.8 | 89 | |
| % Colloidal Particulate Influent | 29.6 | 30.0 | 30.0 | 34.4 | 28.1 | 33.0 | 30.8 |
| % Total Pb Removed | 97.8 | 95.1 | 98.5 | 96.5 | 94.6 | 93.6 | |
| Flow Rate (min./liter) | 0:10:10 | 0:08:17 | 0:08:11 | 0:07:29 | 0:07:37 | 0:07:52 | 0:08:02 |
| PA 2-3 | | | | | | | |
| Effluent Total Pb Conc. (ppb) | 2.51 | 3.17 | 4.23 | 4.43 | 5.16 | 6.42 | 4.3 |
| Influent Total Pb Conc. (ppb) | 154 | 137.9 | 137 | 165.1 | 160.3 | 179.7 | 155.7 |
| % Total Pb Removed | 98.4 | 97.7 | 96.9 | 97.3 | 96.8 | 96.4 | |
| Flow Rate (min/liter) | 9:35 | 9:29 | 9:32 | 9:31 | 9:03 | 8:51 | 0:07:47 |
| PA 3-1 | | | | | | | |
| Effluent Total Pb Conc. (ppb) | — | — | — | 11.2 | 13.05 | 14.45 | 12.9 |
| Influent Total Pb Conc. (ppb) | — | — | — | 158.6 | 138.6 | 137.9 | 145.0 |
| % Total Pb Removed | — | — | — | 92.9 | 90.6 | 89.5 | |
| Flow Rate (min/liter) | 950 | 9:03 | 9:23 | 9:12 | 9:19 | 9:21 | 0:09:16 |
| PA3-2 | | | | | | | |
| Effluent Total Pb Conc. (ppb) | 5.59 | 8.47 | 11.17 | 4.08 | 6.06 | 7.88 | 7.2 |
| Influent Total Pb Conc. (ppb) | 160.8 | 159.8 | 152.4 | 132.1 | 150.5 | 130.6 | 147.7 |
| Influent Sol. Pb Con. (ppb) | 108.6 | 108.2 | 107 | 90.6 | 92.8 | 83.4 | |
| % Particulate Influent | 32.5 | 32.3 | 29.8 | 31.4 | 38.3 | 36.1 | 33.4 |
| % Total Pb Removed | 96.5 | 94.7 | 92.7 | 96.9 | 96.0 | 94.0 | |
| Flow Rate (min./liter) | 0:09:44 | 0:08:00 | 0:08:00 | 0:07:06 | 0:07:18 | 0:07:26 | 0:07:45 |
| PA3-3 | | | | | | | |
| Effluent Total Pb Conc. (ppb) | 2.61 | 3.5 | 4.73 | 1.09 | 2.24 | 1.21 | 2.6 |
| Influent Total Pb Conc. (ppb) | 150.1 | 132.6 | 128.1 | 162.4 | 134.3 | 166.5 | 145.7 |
| % Total Pb Removed | 98.3 | 97.4 | 96.3 | 99.3 | 98.3 | 99.3 | |
| Flow Rate (min/liter) | 10:42 | 9:25 | 10:16 | 10:26 | 9:55 | 9:37 | 0:10:11 |
| PT 2-1 | | | | | | | |
| Effluent Total Pb Conc. (ppb) | 1.15 | 3.1 | 4.7 | 4.64 | 14.76 | 15.56 | 7.3 |
| Influent Total Pb Conc. (ppb) | 152.9 | 160.9 | 150.5 | 157.3 | 137.7 | 136.9 | 149.4 |
| % Total Pb Removed | 99.2 | 98.1 | 96.9 | 97.1 | 89.3 | 88.6 | |
| Flow Rate (min/liter) | 10:34 | 7:41 | 7:42 | 7:32 | 8:26 | 8:15 | 0:08:07 |
| PT2-2 | | | | | | | |
| Effluent Total Pb Conc. (ppb) | 2.82 | 8.32 | 10.17 | 4.46 | 5.88 | 61.26* | 15.5 |
| Influent Total Pb Conc. (ppb) | 160 | 157.2 | 148.4 | 137.9 | 133.5 | 132.6 | 144.9 |
| Influent Sol. Pb Con. (ppb) | 113.9 | 111.3 | 106.6 | 93.2 | 90.8 | 90.4 | |
| % Colloidal Particulate Influent | 28.8 | 29.2 | 28.2 | 32.4 | 32.0 | 31.8 | 30.4 |
| % Total Pb Removed | 98.2 | 94.7 | 93.1 | 96.8 | 95.6 | 53.8 | |
| Flow Rate (min./liter) | 0:12:18 | 0:07:17 | 0:07:10 | 0:06:35 | 0:06:35 | 0:00:15* | 0:06:51 |
| PT 2-3 | | | | | | | |
| Effluent Total Pb Conc. (ppb) | 2.04 | 3.05 | 4.47 | 4.42 | 4.31 | 4.11 | 3.7 |
| Influent Total Pb Conc. (ppb) | 145 | 135 | 134.4 | 160.1 | 134.9 | 161.8 | 145.2 |
| % Total Pb Removed | 98.6 | 97.7 | 96.7 | 97.2 | 96.8 | 97.5 | |
| Flow Rate (min/liter) | 8:48 | 7:36 | 7:42 | 7:43 | 7:11 | 7:03 | 0:07:47 |

*Rig reading error, poured while reservoir still full, bypass of filter

The powder-containing carbon cup-shaped blocks had average flow rates of 8:30 min./liter and many blocks reduced colloidal lead challenged water to below 10 ppb., out to 200% of life, with all but two blocks passing lead removal out to 100% of life. For several filters the influent colloidal lead was monitored. Note that the influent colloidal lead is monitored in all experiments to ensure that the challenge water meets the NSF STD 53-2007 requiring 150±15 ppb total lead with 10-40% in colloidal lead form with greater than 20% of the colloidal lead in the 0.1-1.2 micron size. Additionally, checks have been implemented to ensure the size distribution of the particulate in the experiments.

### Example 7C

Cup-shaped blocks were created with the PA3 formula of Example 7B: powder activated carbon (40 wt. %) and Alusil™ lead sorbent (20 wt. %), but with a 30% increase in the wall thickness. This resulted in a smaller inner surface area. The results are shown in Table X below.

TABLE X

| | 3 L | 76 L | 151 L | 227 L | 273 L | 303 L | average |
|---|---|---|---|---|---|---|---|
| TPA 3-4 | | | | | | | |
| Effluent Total Pb Conc. | 1.41 | 1.83 | 8.07 | 8.83 | | | 5.0 |
| (ppb) | | | | | | | |
| Influent Total Pb Conc. | 158.43 | 158.43 | 159.6 | 159.6 | | | 159.0 |
| (ppb) | | | | | | | |
| % Total Pb Removed | 99.1 | 98.8 | 94.9 | 94.5 | | | |
| Flow Rate (min) | 0:16:22 | 0:10:47 | 0:10:34 | 0:10:07 | | | 0:10:43 |
| TPA 3-2 | | | | | | | |
| Effluent Total Pb Conc. | 1.25 | 6.42 | 10.05 | 6.61 | | | 6.1 |
| (ppb) | | | | | | | |
| Influent Total Pb Conc. | 158.4 | 158.4 | 159.6 | 159.6 | | | 159.0 |
| (ppb) | | | | | | | |
| % Total Pb Removed | 99.2 | 95.9 | 93.7 | 95.9 | | | |
| Flow Rate (min) | 0:14:56 | 0:10:36 | 0:10:39 | 0:10:01 | | | 0:10:28 |

The flow rate slowed down slightly compared to its thinner walled counterpart with no improvement to lead reduction performance.

### Example 7D

Mixed media filters containing granular carbon and ion exchange resin were tested by the method described in Example 7A. The results are shown in Table XI. The filters tested were the current BRITA® gravity-flow mixed media filter, the BRITA® Germany MAXTRA® gravity-flow mixed media filter, and the Proctor and Gamble PUR® 2-stage gravity-flow filter with pleated microfilter. All filters were prepped according the manufactures directions, which included 15 min. of soaking. All filters were tested in the pitcher provided by the manufacturers.

TABLE XI

| Liters Filtered | 3 L | 76 L | 151 L | 227 L | 273 L | 303 L | average |
|---|---|---|---|---|---|---|---|
| Brita Granular | | | | | | | |
| Effluent Total Pb Conc. (ppb) | 39.30 | 40.86 | 42.21 | 42.50 | 46.15 | 41.27 | 42.05 |
| Influent Total Pb Conc. (ppb) | 170.10 | 160.00 | 182.70 | 171.90 | 167.60 | 164.70 | 169.50 |
| Influent Sol. Pb Con. (ppb) | 118.30 | 109.90 | 107.60 | 117.50 | 116.90 | 115.40 | |
| % Colloidal Particulate Influent | 30.5% | 31.3% | 41.1% | 31.6% | 30.3% | 29.9% | 32.5% |
| % Total Pb Removed | 76.9 | 74.5 | 76.9 | 75.3 | 72.5 | 74.9 | |
| Flow Rate (min./liter) | 0:02:50 | 0:06:05 | 0:05:28 | 0:05:59 | 0:06:17 | 0:06:33 | 0:05:32 |
| Maxtra 55:45 | | | | | | | |
| Effluent Total Pb Conc. (ppb) | 36.43 | 40.85 | 43.77 | 45.46 | 46.04 | 45.59 | 43.02 |
| Influent Total Pb Conc. (ppb) | 170.00 | 159.90 | 153.20 | 165.80 | 164.10 | 166.60 | 163.27 |
| Influent Sol. Pb Con. (ppb) | 119.40 | 110.00 | 104.50 | 113.80 | 115.00 | 113.00 | |
| % Colloidal Particulate Influent | 29.8% | 31.2% | 31.8% | 31.4% | 29.9% | 32.2% | 31.0% |
| % Total Pb Removed | 78.6 | 74.5 | 71.4 | 72.6 | 71.9 | 72.6 | |
| Flow Rate (min./liter) | 0:04:41 | 0:04:51 | 0:04:51 | 0:04:39 | 0:04:40 | 0:04:42 | 0:04:44 |
| PUR 2 stage | | | | | | | |
| Effluent Total Pb Conc. (ppb) | 4.85 | 26.06 | 30.24 | NA | NA | NA | 20.38 |
| Influent Total Pb Conc. (ppb) | 170.60 | 159.00 | 152.20 | NA | NA | NA | 160.60 |
| Influent Sol. Pb Con. (ppb) | 117.50 | 113.20 | 110.70 | NA | NA | NA | |
| % Colloidal Particulate Influent | 31.1% | 28.8% | 27.3% | NA | NA | NA | 29.1% |
| % Total Pb Removed | 97.2 | 83.6 | 80.1 | | | | |
| Flow Rate (min./liter) | 0:08:15 | 0:22:59 | 0:16:53 | NA | NA | NA | 0:16:02 |
| PUR 2 stage | | | | | | | |
| Effluent Total Pb Conc. (ppb) | 2.89 | 32.38 | 38.60 | NA | NA | NA | 24.62 |
| Influent Total Pb Conc. (ppb) | 161.10 | 165.20 | 158.00 | NA | NA | NA | 161.43 |
| % Total Pb Removed | 98.2 | 80.4 | 75.6 | | | | |
| Flow Rate (min./liter) | 0:08:13 | 0:12:15 | 0:12:30 | NA | NA | NA | 0:18:52 |
| PUR 2 stage | | | | | | | |
| Effluent Total Pb Conc. (ppb) | 2.95 | 32.56 | 39.56 | NA | NA | NA | 25.02 |
| Influent Total Pb Conc. (ppb) | 162.20 | 138.70 | 149.40 | NA | NA | NA | 150.10 |
| % Total Pb Removed | 98.2 | 76.5 | 73.5 | | | | |
| Flow Rate (min./liter) | 0:07:35 | 0:12:41 | 0:10:58 | NA | NA | NA | 0:15:29 |

All mixed media filters tested fail to adequately reduce total lead concentrations by 50% (75 liters) of filter life. The mixed media filters with the pleated micro filter screen have passing lead removal at 3 liters but then fail at higher quantities. The pleated micro filter results in slow flow rates with averages great than 15 min./liter over the lifespan of the filter (151 liters).

### Example 8

Gravity fed carbon blocks were formed in two shapes: a cup-shaped block having a shape as shown in FIGS. 15A-D, and a cylindrical block as shown in FIG. 2. The blocks are comprised of activated carbon in powder or fiber form, low melt flow high molecular weight binder of 1.0 g/10 min. as determined by ASTM D 1238 at 190° C. and 15 kg load, and a lead sorbent material. For the cup shaped block, the surface area in contact with unfiltered water is defined as the interior portion, but not the upper surface. For the cylindrical block, the surface area in contact with unfiltered water is defined as the exterior surface, but not the upper or lower end surfaces.

TABLE XII

| | Shape | | | |
|---|---|---|---|---|
| | Cup-Shaped Block | | Cylindrical Block | |
| | (FIGS. 20A-D) | | (FIGS. 14A-E) | |
| | Units | | | |
| | in, in², g, | cm, cm³, g, | in, in², g, | cm, cm³, g, |
| | g/in² | g/cm³ | g/in² | g/cm³ |
| volume of block | 6.08 | 99.65 | 9.21 | 151.00 |
| surface area in | 9.65 | 62.21 | 24.66 | 159.44 |
| contact with | | | | |
| unfiltered water | | | | |
| Wall thickness | 0.44 | 1.12 | 0.52 | 1.33 |
| fill weight low | 38.00 | 38.00 | | |
| fill weight high | 44.00 | 44.00 | | |
| block density low | 6.25 | 0.38 | 6.56 | 0.40 |
| block density high | 7.24 | 0.44 | 7.70 | 0.47 |
| surface area in | 1.59 | 0.62 | 2.68 | 1.05 |
| contact with | | | | |
| unfiltered water/ | | | | |
| volume | | | | |

As noted in the Table above, the cylindrical and cup-shaped blocks provide large surface areas in the given volumes.

### Example 9

The following Table lists effluent lead concentration (Ce) in a final liter of water after filtering a specified volume (L) of source water having a pH of 8.5 and containing 90-120 ppb (μg/liter) soluble lead and 30-60 ppb (μg/liter) colloidal lead greater than 0.1 μm in diameter.

Also shown is the average filtration unit time (f), defined as the time it takes to filter one liter of water averaged over all filtered liters in the defined filter lifetime. In preferred embodiments, the average filtration unit time (f) is less than about 12 minutes per liter, and more preferably less than about 6 minutes per liter.

The filter volume (V) is defined as the volume of filtering media or active media. This equates to the hydrated bed volume for mixed media filters and the mold volume for the carbon block filters. In preferred embodiments, the volume of the filter media (V) is less than about 300 cm³, and more preferably less than about 150 cm³.

Data for several filter shapes/types is presented in Table XIII, the filters having formulations as presented above in Examples 7A-D, except as noted. Within the cup-shaped blocks (FIGS. 15A-D), eight different formulations are displayed (FA1, FA2, FA3, FT2, PA1, PA2, PA3, PT2).

TABLE XIII

| | L | | | Cₑ |
|---|---|---|---|---|
| | (gallons) | f (min/liter) | V (cm³) | (mg/liter) |
| Filter | | | | |
| Cup-Shaped: | | | | |
| FA1-1 | 40 | 3.5 | 99.7 | 6.9 |
| FA1-3 | 40 | 3.6 | 99.7 | 17.3 |
| FA2-3 | 40 | 3.4 | 99.7 | 6.9 |
| FA2-4 | 40 | 2.6 | 99.7 | 20.3 |
| FA3-2 | 40 | 3.0 | 99.7 | 6.9 |
| FT2-1 | 40 | 2.9 | 99.7 | 7.8 |
| FT2-3 | 40 | 2.9 | 99.7 | 17.4 |
| PA1-1 | 40 | 9.8 | 99.7 | 3.4 |
| PA1-2 | 40 | 10.9 | 99.7 | 3.9 |
| PA2-1 | 40 | 9.9 | 99.7 | 3.1 |
| PA2-2 | 40 | 8.2 | 99.7 | 2.1 |
| PA2-3 | 40 | 9.5 | 99.7 | 4.2 |
| PA3-2 | 40 | 7.9 | 99.7 | 11.2 |
| PA3-3 | 40 | 10.2 | 99.7 | 4.7 |
| PT2-1 | 40 | 8.0 | 99.7 | 4.7 |
| PT2-2 | 40 | 7.2 | 99.7 | 10.2 |
| PT2-3 | 40 | 7.7 | 99.7 | 4.5 |
| Mixed Media: | | | | |
| Brita Granular | 40 | 5.5 | 128 | 42.2 |
| German Maxtra | 40 | 4.9 | 145 | 43.8 |
| Pur 2 stage w/ timer | 40 | 16.0 | 141 | 30.2 |
| Pur 2 stage w/ timer | 40 | 10.4 | 141 | 36.6 |
| Pur 2 stage w/ timer | 40 | 11.0 | 141 | 38.6 |

As evident from Table XIII, the cup-shaped filters exhibited superior lead removal and fast flow rates.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A gravity-fed carbon block water filter, comprising:
activated carbon particles;
a binder material interspersed with the activated carbon particles; and
a lead scavenger coupled to at least one of the activated carbon particles and binder material, the lead scavenger being for removing lead from water,
wherein a lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter,
wherein the water has an average flow rate of at least 0.1 liter per minute through the filter with a head pressure of between approximately 0.1 and 1.0 psi.

2. The water filter as recited in claim 1, wherein the lead scavenger is a zirconia hydroxide.

3. The water filter as recited in claim 1, wherein the binder material is hydrophobic.

4. The water filter as recited in claim 1, wherein the binder material has a melt index that is less than 1.8 g/10 min as determined by ASTM D 1238 at 190° C. and 15 kg load.

5. The water filter as recited in claim 1, wherein the binder material has a melt index that is less than 1.0 g/10 min as determined by ASTM D 1238 at 190° C. and 15 kg load.

6. The water filter as recited in claim 1, wherein the structure of the block is characterized by having been compressed no more than 10% by volume during fabrication of the filter.

7. A gravity-flow system for filtering water, comprising:
a container having a source water reservoir than can hold source water and a filtered water reservoir that can hold filtered water;
a cartridge in communication with both the source water reservoir and the filtered water reservoir, the cartridge providing a path through which water can flow from the source water reservoir to the filtered water reservoir; and
a carbon block filter as recited in claim 1 disposed within the cartridge.

8. A gravity-fed carbon block water filter, comprising:
activated carbon particles; and
a binder material interspersed with the activated carbon particles, wherein the binder material has a melt index that is less than 1.8 g/10 min as determined by ASTM D 1238 at 190° C. and 15 kg load,
wherein a structure of the block is characterized by having been compressed less than about 10% by volume during fabrication of the filter,
wherein a lead concentration in a final liter of effluent water filtered by the filter is less than about 10 pg/liter after about 151 liters (40 gallons) of source water filtration, the source water having a pH of 8.5 and containing 135-165 parts per billion total lead with 30-60 parts per billion thereof being colloidal lead greater than 0.1 μm in diameter,
wherein water passing through the filter has an average flow rate of at least 0.1 liter per minute through the filter with a head pressure of between approximately 0.1 and 1.0 psi.

9. The water filter as recited in claim 8, wherein the binder material has a melt index that is less than 1.0 g/10 min as determined by ASTM D 1238 at 190° C. and 15 kg load.

10. The water filter as recited in claim 8, further comprising about 5-40 wt % of additional active material including a lead scavenger.

11. The water filter as recited in claim 10, wherein the lead scavenger is a zirconia hydroxide.

12. The water filter as recited in claim 8, wherein the binder material is hydrophobic.

13. A gravity-fed carbon block water filter, comprising:
about 20-90 wt % activated carbon particles; and
about 5-50 wt % binder material, the binder material being interspersed with the activated carbon particles and coupled thereto such that a cavity is formed,
wherein a ratio of a surface area A (cm²) of the filter in contact with unfiltered water to a volume V (cm³) of the activated carbon particles, binder material, and any additional materials is greater than about 0.5 cm⁻¹,
wherein the water has an average flow rate of at least 0.1 liter per minute through the filter with a head pressure of between approximately 0.1 and 1.0 psi.

14. The water filter as recited in claim 13, wherein the ratio is less than about 5.

15. The water filter as recited in claim 13, wherein the ratio is less than about 3.

16. The water filter as recited in claim 13, further comprising about 5-40 wt % of additional active material including a lead scavenger.

17. The water filter as recited in claim 16, wherein the lead scavenger is a zirconia hydroxide.

18. The water filter as recited in claim 16, wherein a lead concentration in a final liter of effluent water filtered by the filter is less than about 10 μg/liter after about 151 liters (40 gallons) of source water filtration, the source water having a pH of 8.5 and containing 135-165 parts per billion total lead with 30-60 parts per billion thereof being colloidal lead greater than 0.1 μm in diameter.

19. The water filter as recited in claim 13, wherein the binder material is hydrophobic.

20. A gravity-flow system for filtering water, comprising:
a container having a source water reservoir than can hold source water and a filtered water reservoir that can hold filtered water;
a cartridge in communication with both the source water reservoir and the filtered water reservoir, the cartridge providing a path through which water can flow from the source water reservoir to the filtered water reservoir; and
a carbon block filter as recited in claim 13 disposed within the cartridge.
